(19) United States
(12) Patent Application Publication
(10) Pub. No.: US 2024/0065917 A1
(43) Pub. Date: Feb. 29, 2024

(54) DEVICE FOR ASSISTING WITH WRIST MOTION

(71) Applicant: ERMI LLC, Atlanta, GA (US)

(72) Inventors: Shaun Kevin Stinton, Atlanta, GA (US); Thomas P. Branch, Atlanta, GA (US); Ed Dittmar, Dunwoody, GA (US); Jared Dittmar, Marietta, GA (US)

(21) Appl. No.: 18/458,582

(22) Filed: Aug. 30, 2023

Related U.S. Application Data
(60) Provisional application No. 63/402,114, filed on Aug. 30, 2022.

(51) Int. Cl. A61H 1/02

(52) U.S. Cl. CPC A61H 1/0285; A61H 2201/0149; A61H 2201/1246; A61H 2201/1253; A61H 2201/1635; A61H 2201/1671; A61H 2201/1676

(57) ABSTRACT

A device for manipulating a user's hand a wrist portion and forearm portion, each having proximal and distal ends. A pivoting connection is operatively coupled with the proximal end of the wrist portion and distal end of the forearm portions such that the wrist portion is pivotally coupled to the forearm portion. The device has a first actuator operatively coupled to the wrist portion and a second actuator operatively coupled to the pivoting connection. The first actuator is configured to apply a rotational force to a hand support coupled to the wrist portion, thereby producing either supination or pronation of a user's wrist. The second actuator is configured to apply a rotational force to the pivoting connection, thereby producing either flexion, extension, abduction, or adduction of a user's wrist, depending upon whether the user's hand is palm-side down or in a thumb's up position.

### CROSS REFERENCE TO RELATED APPLICATION

This application claims the benefit of U.S. Provisional Patent Application Ser. No. 63/402,114, filed Aug. 30, 2022. This application is also generally related to PCT Patent Application US2022/026609 filed on Apr. 27, 2022. This application is further generally related U.S. Pat. No. 10,278,881 published on May 7, 2019, and U.S. patent application Ser. No. 14/569,627 filed Dec. 13, 2014. The entirety of the PCT Patent Application US2022/026609, U.S. Pat. No. 10,2782,881, and U.S. patent application Ser. No. 14/569,627 are expressly incorporated herein by reference.

### FIELD

This invention relates generally to the field of orthopedic devices, and more particularly embodiments of the invention relate to orthopedic devices designed to improve and promote stretching of a wrist joint in three different planes of motion including pronation or supination, flexion or extension, and radial or ulnar deviation, or a combination of such planes of motion.

### BACKGROUND

When a joint is damaged either from an injury event or through surgical intervention, scar tissue may form and limit the motion of the joint. This loss of motion can greatly affect a person's quality of life by limiting their ability to accomplish their normal activities of daily living. Traditionally, orthopedic devices designed to help recover joint range of motion are separated into two categories: (1) braces or orthotics that can be worn to support and protect limbs; or (2) mechanical devices that are designed to allow the application of force similar to how a physical therapist may apply force.

Different joints are capable of moving in different directions, and the full range of motion of a joint depends upon the anatomy of the particular joint and on the particular individual. Joint motion of the wrist can generally be defined as flexion (up), extension (down), abduction or ulnar deviation (little finger side of hand moving away from the body), adduction or radial deviation (thumb side of the hand moving towards the body), pronation (palm facing down), and supination (palm facing up). While a joint may have a predominant axis of movement or rotation, motion around the other axes are important for promoting full functionality of the joint.

Conventional orthotic devices designed to improve motion and movement of a joint typically provide support for a joint while being worn by a user. These devices utilize a rigid member or hinged joint and apply a force around a single axis, or in a single direction of movement, to encourage the return of motion to that joint. However, wearing such an orthotic device may allow for a user to experience undesirable motion of the particular joint if the orthotic is worn incorrectly, thereby impeding a user's improvement in motion to the particular joint.

In view of the circumstances described above, there is a need for a system that can assist in improving range of motion of a joint in more than just a single plane of motion.

### BRIEF SUMMARY

Embodiments of the present invention address the above needs and/or achieve other advantages by providing systems, apparatuses, and methods that assist with manipulating a hand/wrist/forearm of a user to provide pronation/supination, flexion/extension, and radial/ulnar deviation assistance. The device includes an arm engagement system having a wrist portion, a forearm portion, a pivoting connection and a force application system. The wrist portion has a proximal end and distal end. The distal end of the wrist portion has a bracket with a hand engagement member pivotally coupled to the wrist portion by the bracket. The forearm portion has a proximal end and distal end, where the proximal end includes a forearm pad. The pivoting connection operatively couples with the proximal end of the wrist portion and the distal end of the forearm portion such that the wrist portion is pivotally coupled to the forearm portion about the pivoting connection. The force application system includes: (1) a first actuator operatively coupled to the hand engagement member; and (2) a second actuator operatively coupled at or near the pivoting connection. The first actuator is configured to apply a rotational force to the hand engagement member, thereby producing at least one of a supination movement a pronation movement to a user's wrist. The second actuator is configured to apply a rotational force to the pivoting connection, thereby producing at least one of a flexion movement, extension movement, ulnar deviation, and a radial deviation of a user's wrist.

Herein disclosed is also a method of using a device for improving a user's wrist movements including pronation, supination, flexion, extension, radial deviation, and ulnar deviation of the user's wrist. The method includes: (1) providing an arm engagement system, the arm engagement system having a wrist portion, a forearm portion, and a pivoting connection pivotally coupling the wrist portion and the forearm portion, wherein the wrist portion includes a hand engagement member configured for receiving a user's hand; (2) providing a force application system, the force application system having: (a) a first actuator having a first axis of rotation, wherein the first actuator is operatively coupled to the wrist portion, and wherein the first actuator is configured to rotate the hand engagement member between a first position and a second position; (b) a second actuator having a second axis of rotation, wherein the second actuator is operatively coupled at the pivoting connection with the wrist portion and the forearm portion; and (c) a power unit assembly configured to, in a first mode, actuate the first actuator, and in a second mode, actuate the second actuator; (3) wherein, when the wrist portion and the forearm portion are aligned in a straight line, the hand engagement member is in the first position, and the power unit assembly is in the first mode, the first actuator causes the arm engagement system to move a user's wrist between supination and pronation; (4) wherein, when the wrist portion and the forearm portion are aligned in a straight line, the hand engagement member is in the first position, and the power unit assembly is in the second mode, the second actuator causes the arm engagement system to move a user's wrist between ulnar deviation and radial deviation; and (5) wherein, when the wrist portion and the forearm portion are aligned in a straight line, the hand engagement member is in the second position, and the power unit assembly is in the second mode, the second actuator cause the arm engagement system to move a user's wrist between flexion and extension.

In example embodiments, a device is disclosed herein for improving a user's pronation, supination, flexion, extension, radial deviation, and ulnar deviation wrist movements, the device including an arm engagement system and a force application system. The arm engagement system includes a wrist portion, a forearm portion, and a pivoting connection pivotally coupling the wrist portion and the forearm portion, wherein the wrist portion includes a hand engagement member configured for receiving a user's hand. The force application system includes a first actuator having a first axis of rotation, wherein the first actuator is operatively coupled to the wrist portion, where the first actuator is configured to rotate the hand engagement member between a first position and a second position. The force application system also includes a second actuator having a second axis of rotation, wherein the second actuator is operatively coupled at the pivoting connection with the wrist portion and the forearm portion. Finally, the force application system includes a power unit assembly configured to, in a first mode, actuate the first actuator, and in a second mode, actuate the second actuator. When the wrist portion and the forearm portion are aligned in a straight line, the hand engagement member is in the first position, and the power unit assembly is in the first mode, the first actuator causes the arm engagement system to move a user's wrist between supination and pronation.

In some embodiments, the device includes an arm engagement system and a force application system. The arm engagement system includes a proximal arm member with a proximal arm frame. The proximal arm frame has a proximal end, a distal pivot end, and a posterior elbow pad configured to engage a bottom of the user's elbow. The arm engagement system further includes a distal arm member with a distal arm frame having a proximal pivot end and a distal end. The arm engagement system also includes a hand engagement member configured to receive and engage the hand of the user. A first pivoting connection is operatively coupled between the distal arm frame and the hand engagement member such that the hand engagement member is configured to pivot on an axis defined about an axis defined along a forearm of the user as the hand of the user pronates or supinates. The force application system includes a force applicator operatively connected between the distal arm frame and the hand engagement member and configured to apply a force to the hand engagement member to manipulate the hand of the user to provide flexion/extension stretching or radial/ulnar deviation stretching depending on the orientation of the hand engagement member.

In at least one embodiment, the force application system may include a second force applicator operatively connected between the proximal arm frame and the distal arm frame and configured to apply a force to the hand engagement member to pivot the hand engagement member about the vertical axis.

In additional or alternative embodiments, at least one of the first force applicator or the second force applicator may include one or more hydraulic actuators. In an additional or alternative embodiment, the force application system may include a switch and a force generator. The switch may be configured to allow the user to selectively, operably couple the force generator to the force applicator or the second force applicator. In an additional or alternative embodiment, the force application system may include a switch and a second force generator. The switch may be configured to allow the user to selectively operate the force generator and pivot the hand engagement member about the first pivoting connection or selectively operate the second force generator and pivot the hand engagement member about the second pivoting connection. In some embodiments, the force generator may include at least one of a pressure source, a pump, a compressor, a hydraulic pump, a hydraulic compressor, a pneumatic pump, a pneumatic compressor, an electric motor, or an electric actuator.

In additional or alternative embodiments, the device further includes a seat coupled to the arm engagement system such that the device is configured for the user to be seated while using the device. Additionally or alternatively, the proximal arm member may be slidably coupled to the chair such that a vertical height of the hand engagement member may be altered. Additionally or alternatively, the device may include a third connection operatively coupled between the arm engagement system and the chair. In some embodiments, the third connection may be configured such that the arm engagement system may pivot about an axis defined perpendicular to the vertical axis and the axis defined along the forearm of the user. In further or alternative embodiments, the third connection may be configured such that the proximal arm may translate relative to the chair. In some embodiments, the posterior elbow pad may define an L-shape. Additionally or alternatively, the posterior elbow pad may be selectively coupled to the proximal arm frame. In some embodiments, the posterior elbow pad may include a posterior elbow pad assembly. Additionally or alternatively, the posterior elbow pad assembly may include an inner lateral support and an outer lateral support. In some embodiments, the posterior elbow pad assembly may be configured such that the inner lateral support and the outer lateral support may selectively translate in the lateral direction.

In some embodiments, the hand engagement member may define a “U”-shaped (or taco-shell-shaped) cavity configured to engage the hand of the user. Additionally or alternatively, the hand engagement member may include at least one pair of vertical engagement members operatively coupled with a linear actuator. In further or alternative embodiments, the hand engagement member may include a vertical phalanges member configured such that fingers of the hand of the user may be engaged with the vertical phalanges member, when the device is in use.

In some embodiments, the linear actuator may include at least one adjustable threaded engagement. In additional or alternative embodiments, the linear actuator may include at least one biasing member. In at least some embodiments, the hand engagement member may be configured as a hand envelop cavity configured to at least partially envelop the hand. In additional or alternative embodiments, the hand engagement member may define a “V”-shaped (such as a bisected cylinder shaped or a Pacman shaped) cavity configured to engage the hand of the user.

In an additional or alternative aspect, the present subject matter is directed to a device for manipulating a hand of a user to provide pronation or supination assistance. The device includes an arm engagement system including a proximal arm member. The proximal arm member includes a proximal arm frame extending along a proximal frame longitudinal direction from proximal end to a distal pivot end. The proximal arm frame further includes a posterior elbow pad configured to engage a bottom of the user's elbow. A distal arm member of the arm engagement system includes a distal arm frame extending along a distal frame longitudinal direction from a proximal pivot end to a distal pivot end. A hand engagement member of the arm engagement system is configured to receive and engage the hand of the user. A first pivoting connection is operatively coupled between the distal pivot end of the proximal arm frame and the proximal pivot end of the distal arm frame such that the hand engagement member is configured to pivot about an axis of rotation perpendicular to at least one of the proximal frame longitudinal direction or the distal frame longitudinal direction. The device further includes a force application system including a force applicator operatively connected between the proximal arm frame and the distal arm frame. The force applicator is configured to apply a force to the hand engagement member to manipulate the hand of the user to rotate about the axis of rotation.

In some embodiments, the hand engagement member may be configured such that applying the force to the hand engagement member manipulates the hand of the user to provide for flexion or extension assistance of the wrist. In additional or alternative embodiments, the hand engagement member may be configured such that applying the force to the hand engagement manipulates the hand of the user to provide for radial deviation or ulnar deviation assistance. In a further or alternative embodiment, the arm engagement system may further include a second pivoting connection operatively coupled between distal arm frame and the hand engagement member. Additionally or alternatively, the hand engagement member may be configured to pivot about the second pivoting connection between a first position suitable for flexion or extension assistance of the wrist and a second position suitable for radial deviation or ulnar deviation assistance.

In some embodiments, the hand engagement member may be configured to pivot about the second pivoting connection and about an axis defined along a forearm of the user as the hand of the user pronates or supinates. In additional or alternative embodiments, the force application system may further include a second force applicator operatively connected between the distal arm frame and the hand engagement member. In a further or alternative embodiment, the second force applicator may be configured to apply a force to the hand engagement member to manipulate the hand of the user to provide pronation or supination assistance.

The features, functions, and advantages that have been discussed may be achieved independently in various embodiments of the present invention or may be combined in yet other embodiments, further details of which can be seen with reference to the following description and drawings. Embodiments of the invention can include one or more or any combination of the above features and configurations.

Additional features, aspects, and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE SEVERAL VIEWS OF THE DRAWINGS

These and other features, aspects and advantages of the present invention are better understood when the following detailed description of the invention is read with reference to the accompanying drawings, in which:

FIG. 1 is a front perspective view of a device for assisting with wrist motion, according to an example embodiment of the invention;

FIG. 2 is a rear perspective view of the device of FIG. 1;

FIG. 3 is a rear perspective view of the device of FIG. 1;

FIG. 4 is a front perspective view of the device of FIG. 1;

FIG. 5 is a partial front perspective view of an arm engagement system of the device of FIG. 1 in a first orientation;

FIG. 6 is a partial front perspective view of an arm engagement system of the device of FIG. 1 in a second orientation;

FIG. 7 is a partial front perspective view of an arm engagement system of the device of FIG. 1;

FIG. 8 is a partial front perspective view of an arm engagement system of the device of FIG. 1;

FIG. 9 is a partial front perspective view of an arm engagement system of the device of FIG. 1;

FIG. 10 is a front perspective view of a device for assisting with wrist motion, according to another example embodiment of the invention;

FIG. 11 is a rear perspective view of the device of FIG. 10;

FIG. 12 is a side perspective view of a first side of the device of FIG. 10;

FIG. 13 is a rear view of the device of FIG. 10;

FIG. 14 is a side view of a second side of the device of FIG. 10;

FIG. 15 is a side view of the first side of the device of FIG. 10;

FIG. 16 is a partial front view of the device of FIG. 10;

FIG. 17 is a partial side view of the first side of the device of FIG. 10;

FIG. 18 is a top view of the device of FIG. 10;

FIG. 19 is a partial rear view of the device of FIG. 10;

FIG. 20 is a partial front perspective view of the device of FIG. 10;

FIG. 21 is a perspective view of a first side of a device for assisting with wrist motion according to another example embodiment of the invention;

FIG. 22 is a side view of the first side of the device of FIG. 21;

FIG. 23 is a partial perspective view of the first side of the device of FIG. 21;

FIG. 24 is a partial top view of the device of FIG. 21;

FIG. 25 is a partial top view of the device of FIG. 21;

FIG. 26 is a partial perspective rear view of a second side of the device of FIG. 21;

FIG. 27 is a partial perspective rear view of the first side of the device of FIG. 21;

FIG. 28 is a partial perspective front view of the first side of the device of FIG. 21;

FIG. 29 is a partial perspective rear view of a second side of the device of FIG. 21;

FIG. 30 is a perspective view of a hand engagement member for use with the device of FIG. 1 or FIG. 21;

FIG. 31 is a perspective view of a hand engagement member for use with the device of FIG. 1 or FIG. 21, according to another example embodiment of the invention;

FIG. 32 is a partial rear view of the hand engagement member of FIG. 31;

FIG. 33 is a perspective view of a hand engagement member for use with the device of FIG. 1 or FIG. 21, according to another example embodiment of the invention;

FIG. 34 is a perspective view of a hand engagement member for use with the device of FIG. 1 or FIG. 21, according to another example embodiment of the invention;

FIG. 35 is a perspective view of a hand engagement member for use with the device of FIG. 1 or FIG. 21, according to another example embodiment of the invention;

FIG. 36 is a perspective view of the hand engagement member of FIG. 35;

FIG. 37 is a partial view of a force application system for use with the device of FIG. 1 or FIG. 21, according to another example embodiment of the invention;

FIG. 38 is a partial view of a force application system for use with the device of FIG. 1 or FIG. 21, according to another example embodiment of the invention;

FIG. 39 is a partial view of a force application system for use with the device of FIG. 1 or FIG. 21, according to another example embodiment of the invention;

FIG. 40 is a block diagram of an exemplary control system for use with the device of FIG. 1 or FIG. 21, according to an example embodiment of the invention;

FIG. 41 is a schematic drawing of a hydraulic system pump for use with the device of FIG. 1 or FIG. 21, according to an example embodiment of the invention;

FIG. 42 is a partial view of a force application system for use with the device of FIG. 1 or FIG. 21, according to an example embodiment of the invention;

FIG. 43A is a front perspective view of the device of FIG. 1 oriented for assisting with the motion of a shoulder, according to an example embodiment of the invention;

FIG. 43B is a perspective view of an arm engagement system for use with the device of FIG. 1 or FIG. 21, according to an example embodiment of the invention;

FIGS. 44A-44B are a top perspective view of an elbow pad for use with the device of FIG. 1 or FIG. 21, according to another example embodiment of the invention;

FIG. 45 is a bottom perspective view of the elbow pad of FIGS. 44A and 44B.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

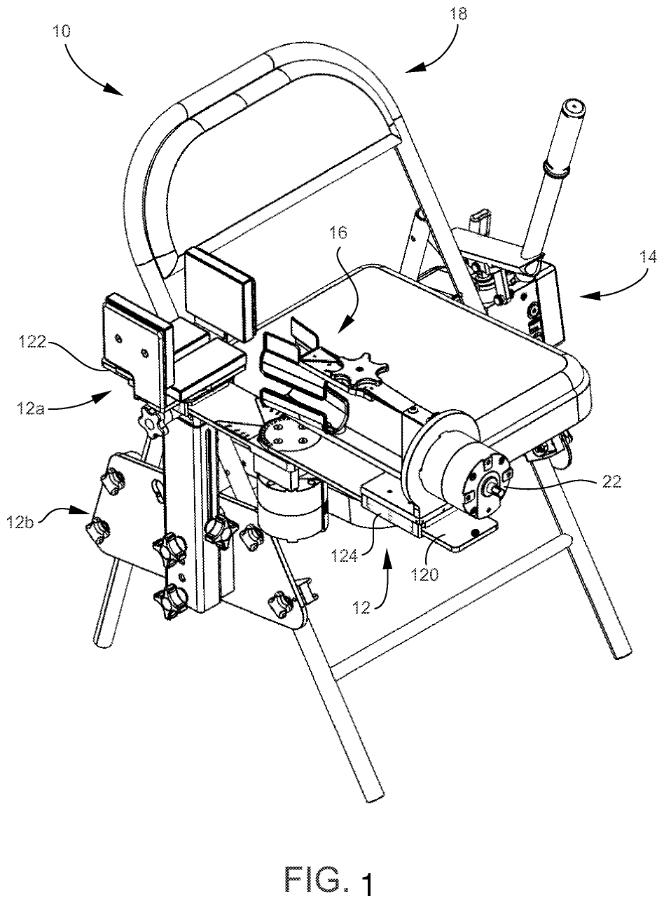

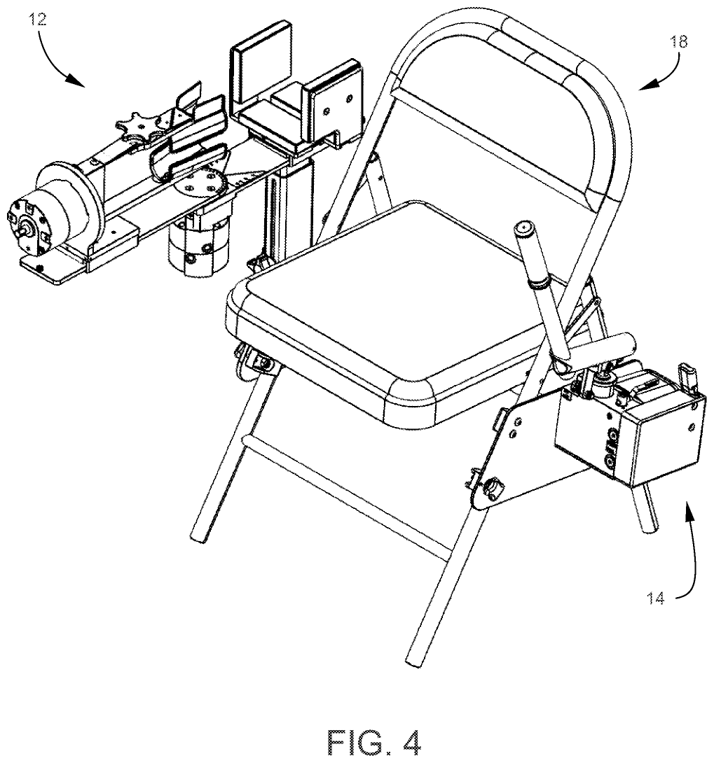

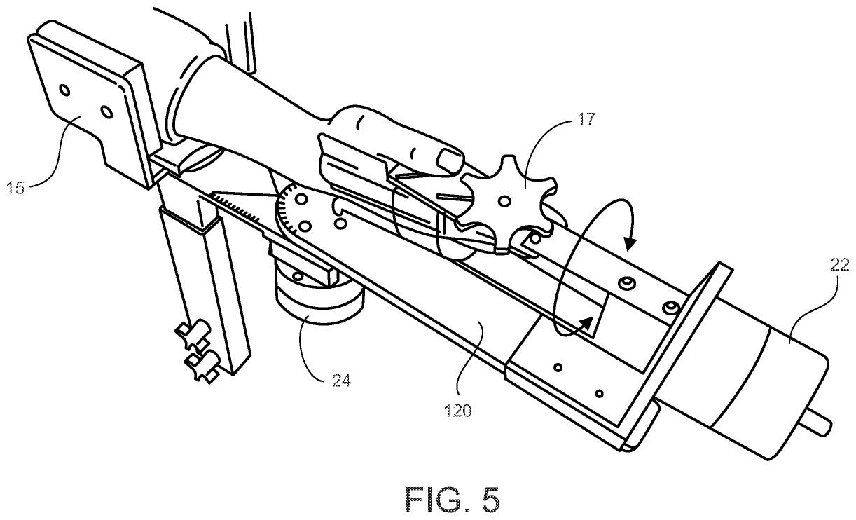

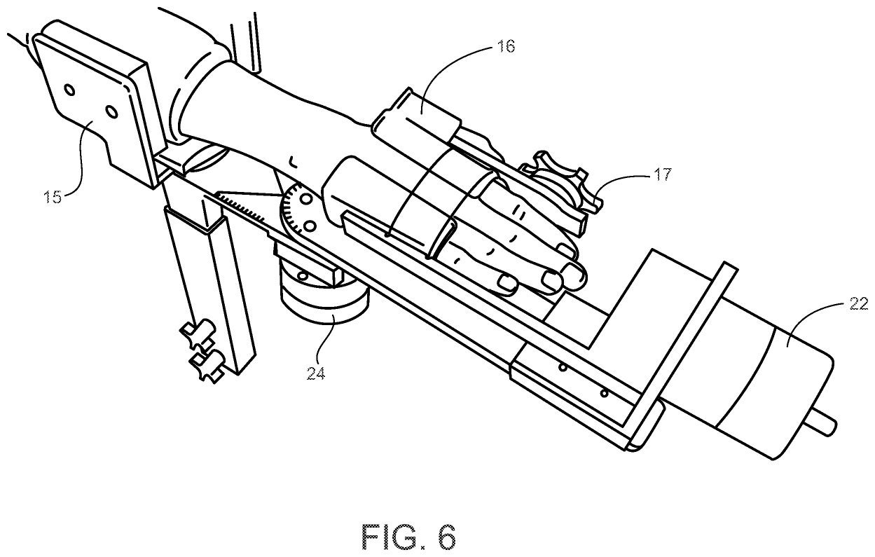

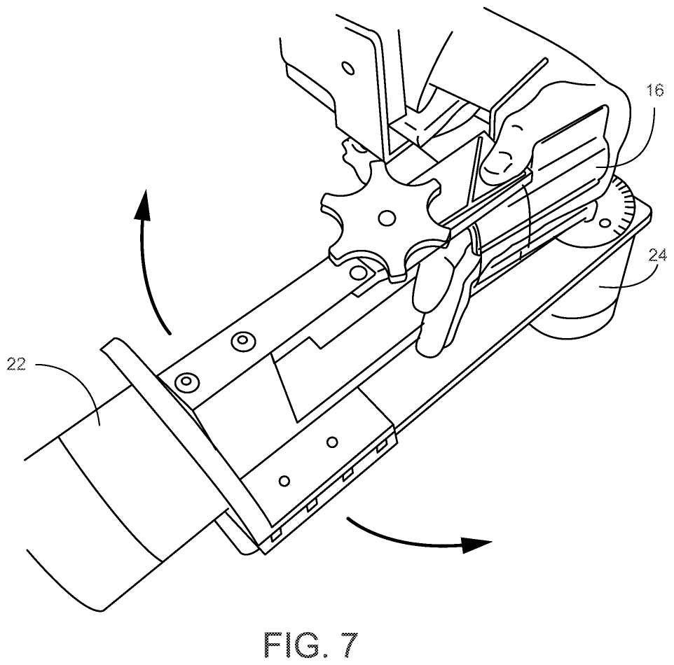

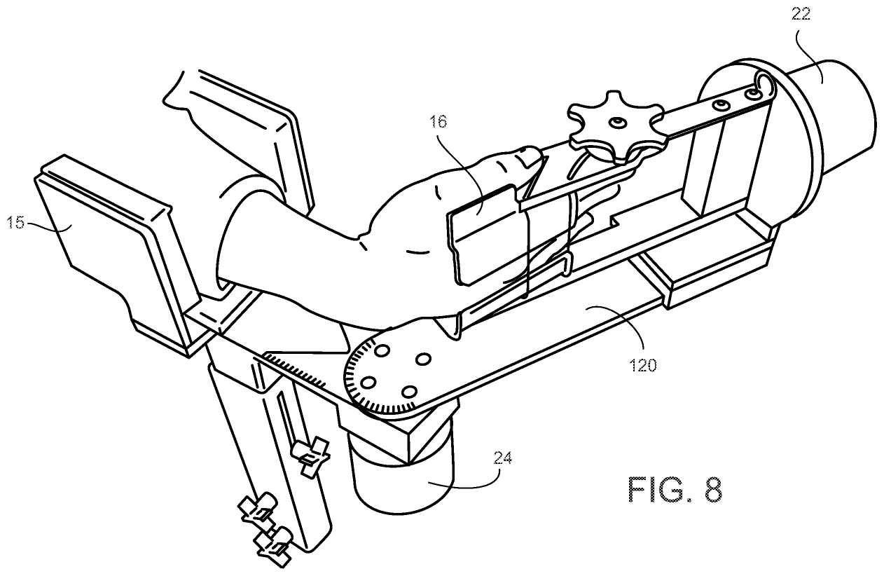

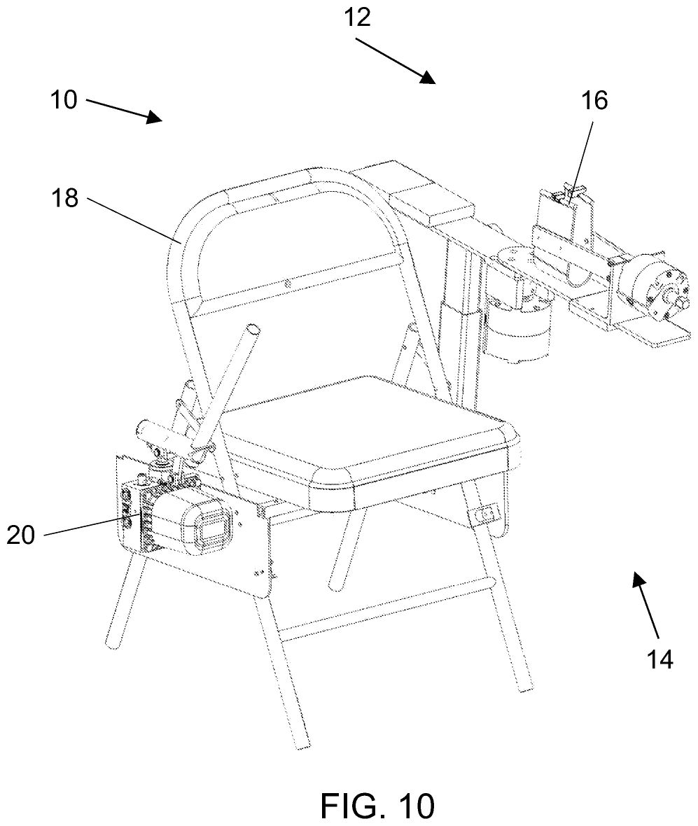

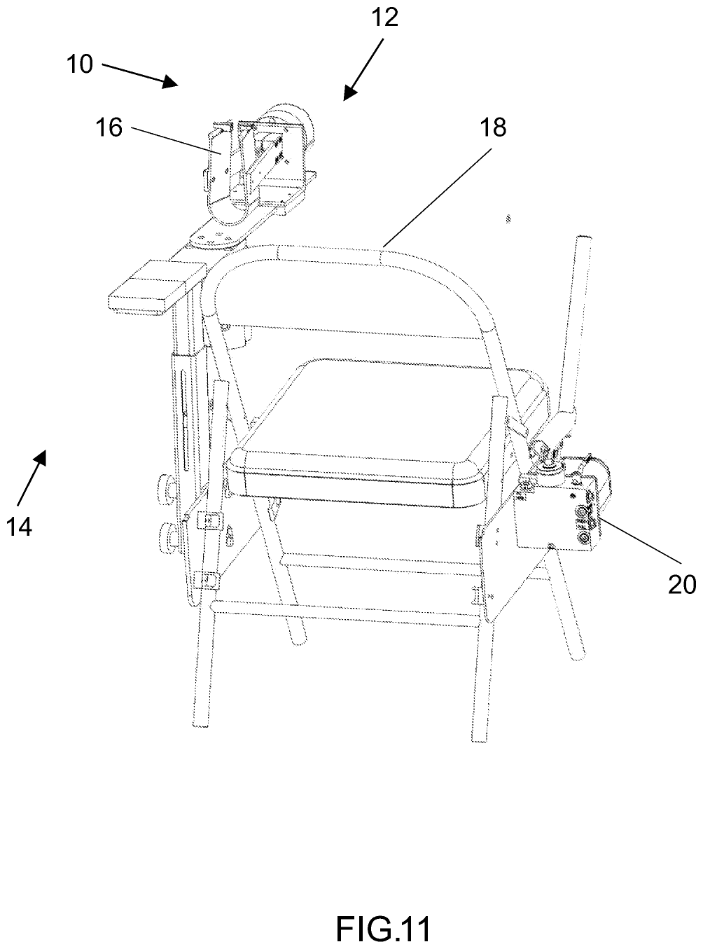

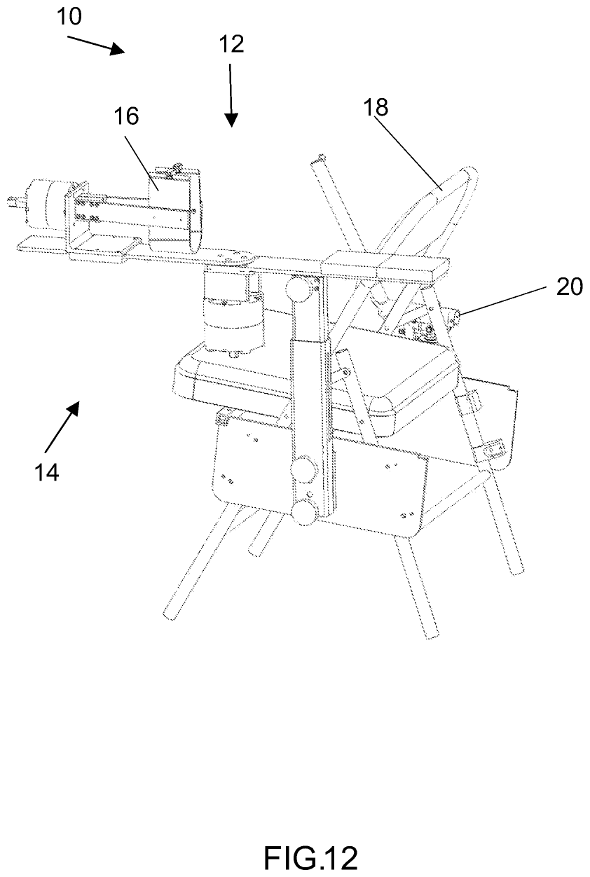

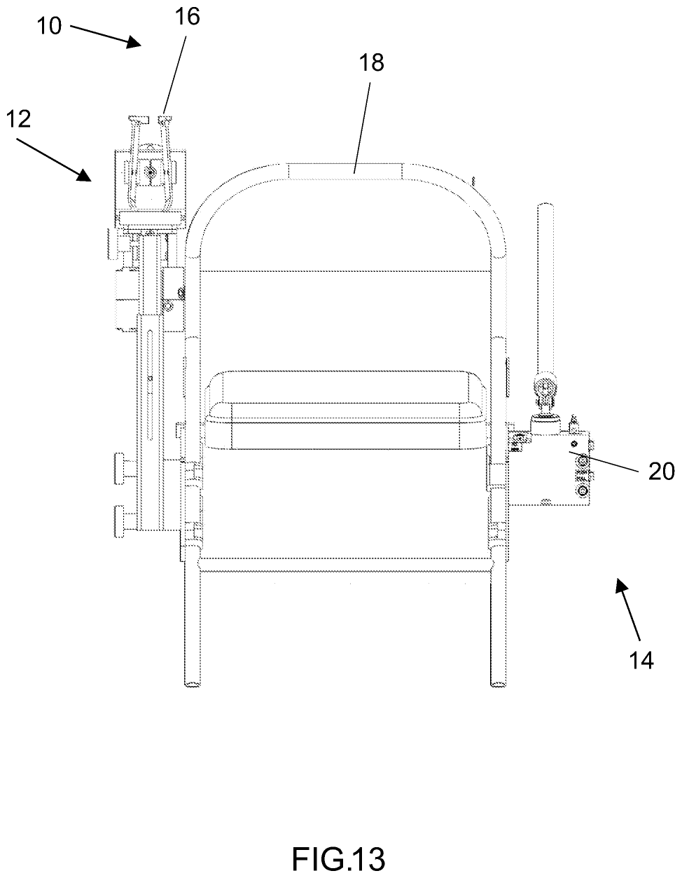

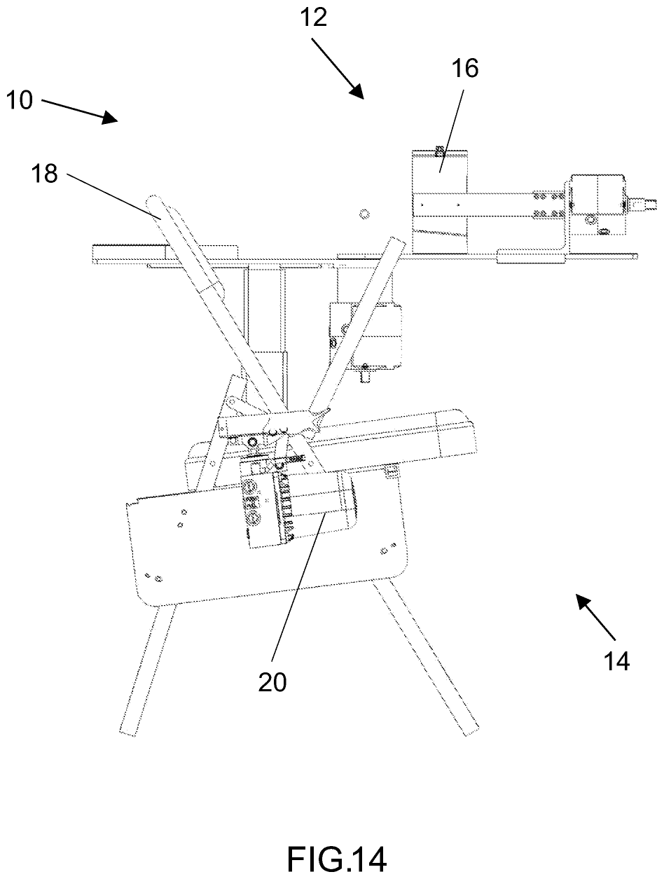

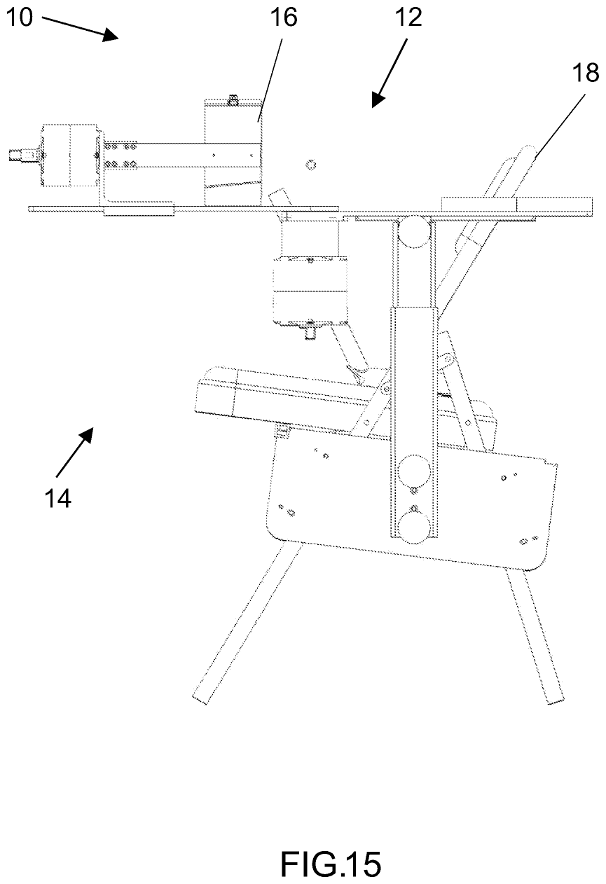

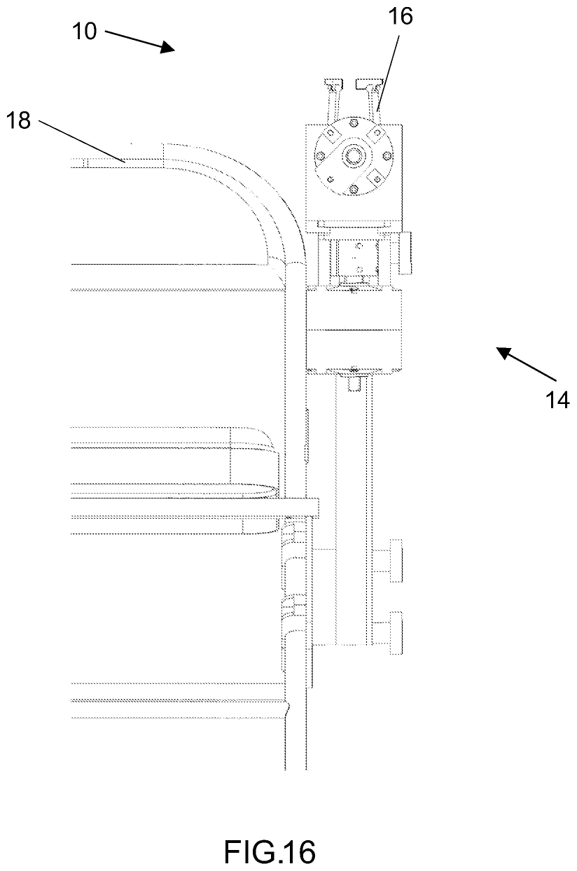

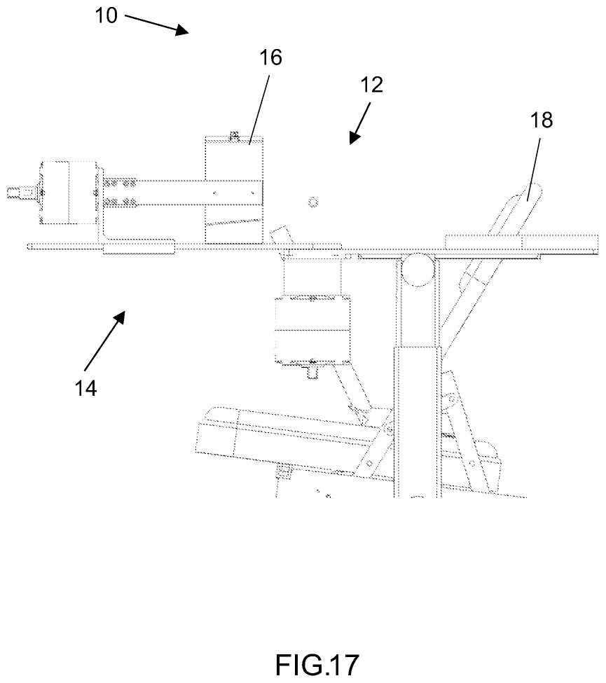

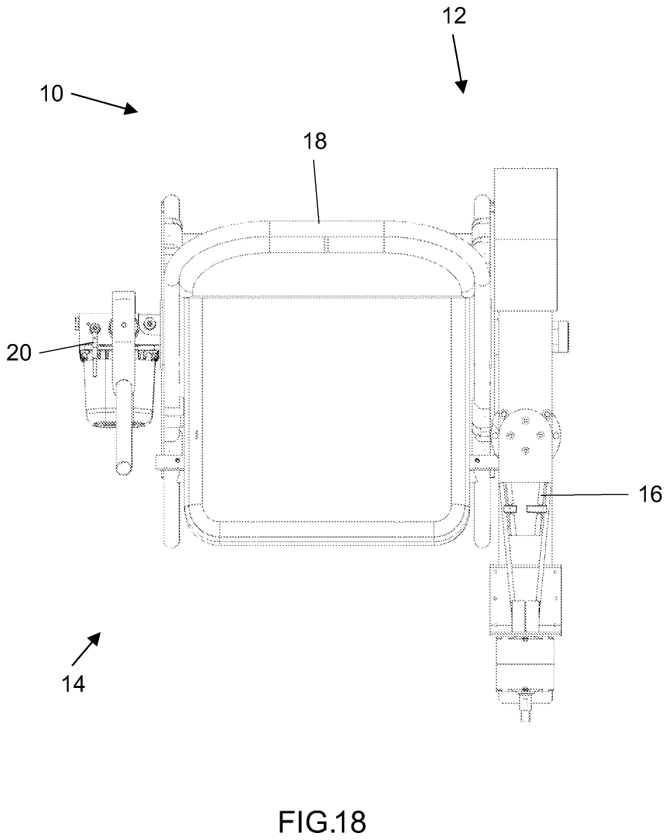

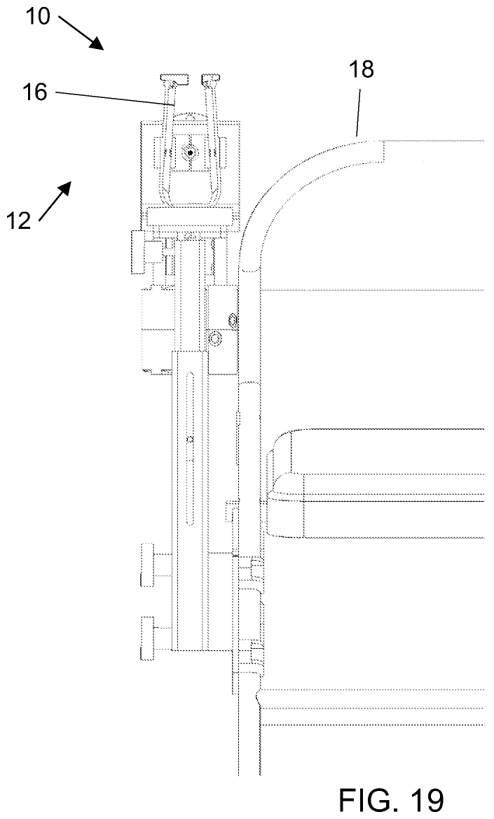

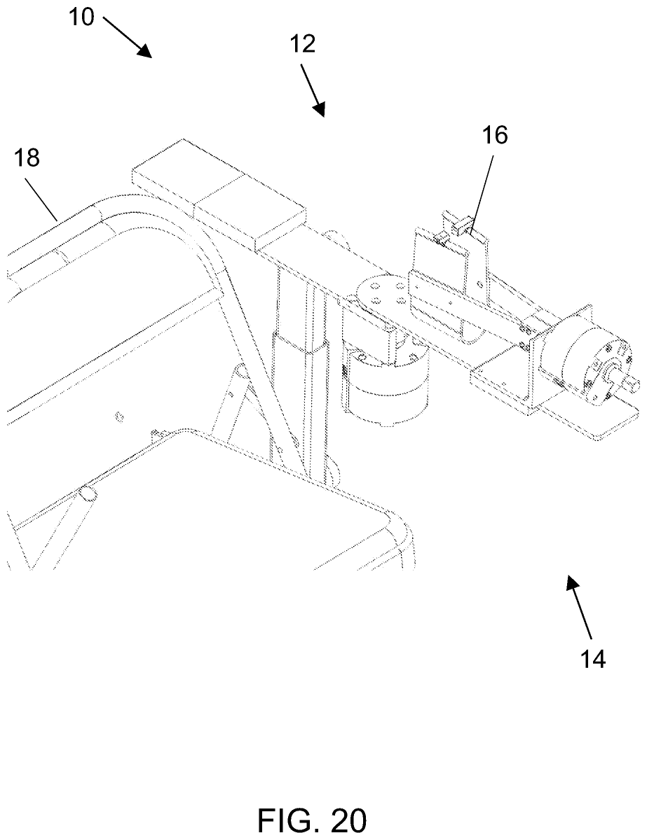

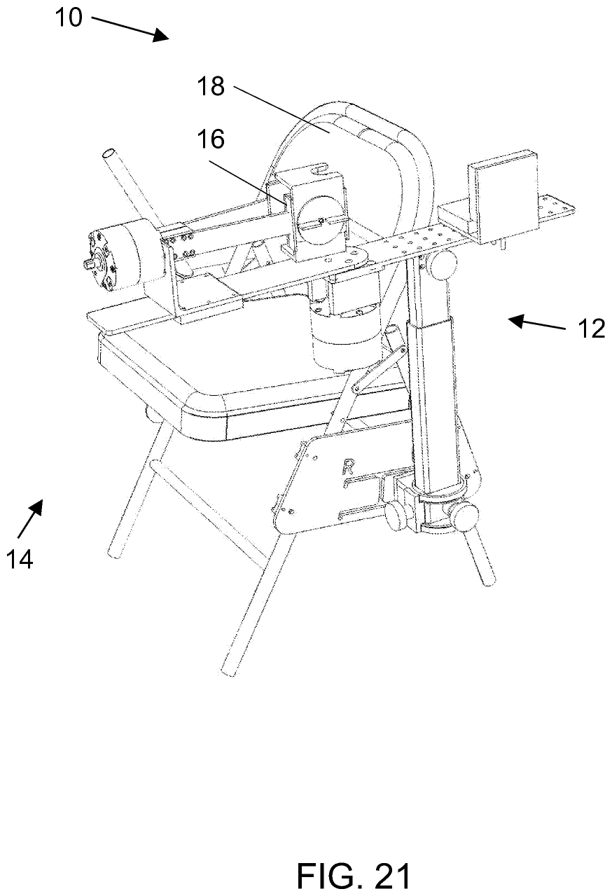

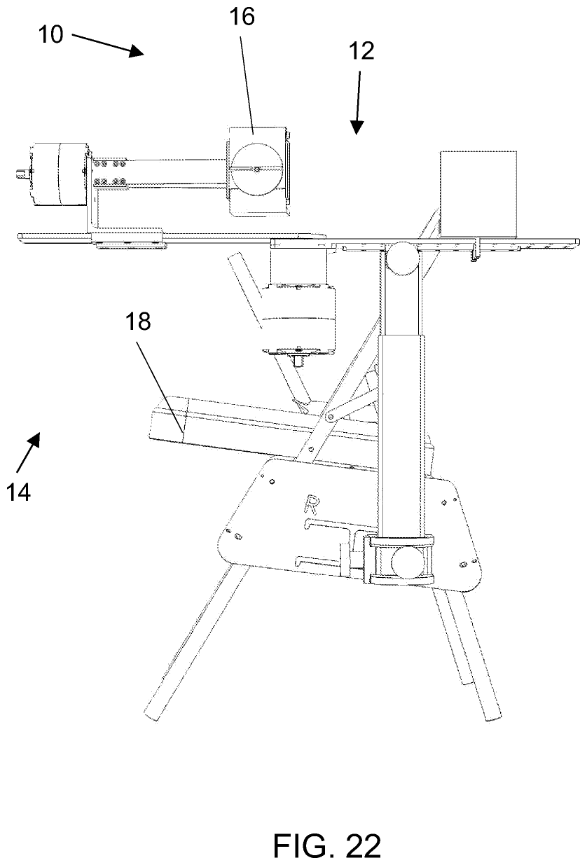

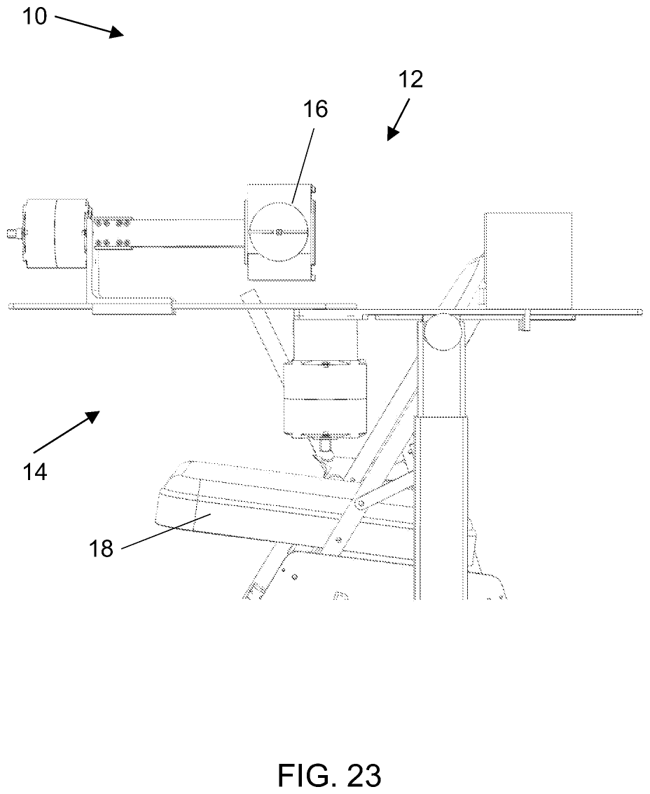

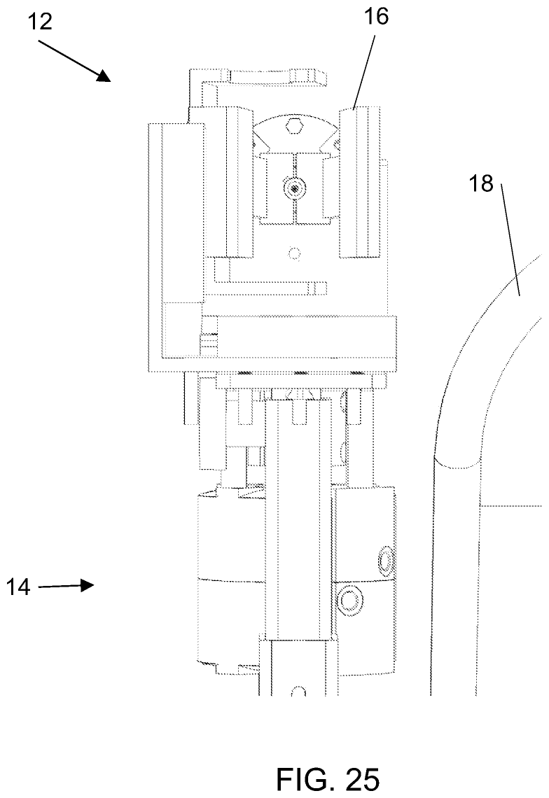

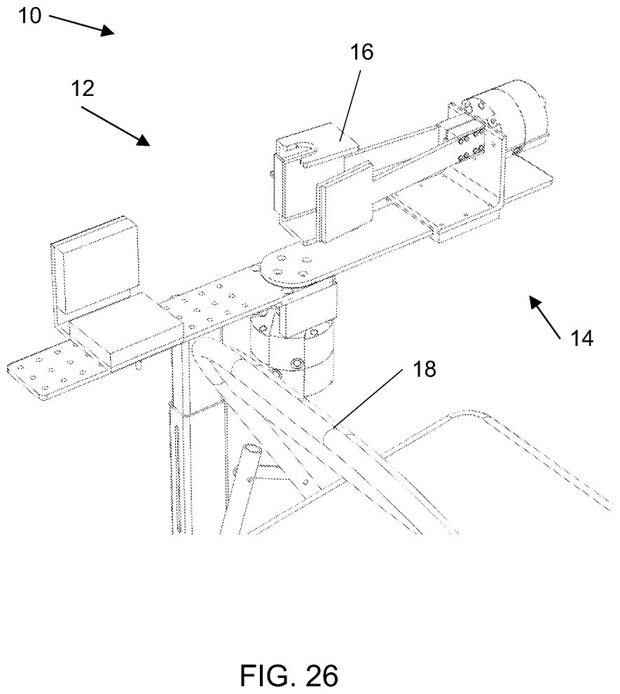

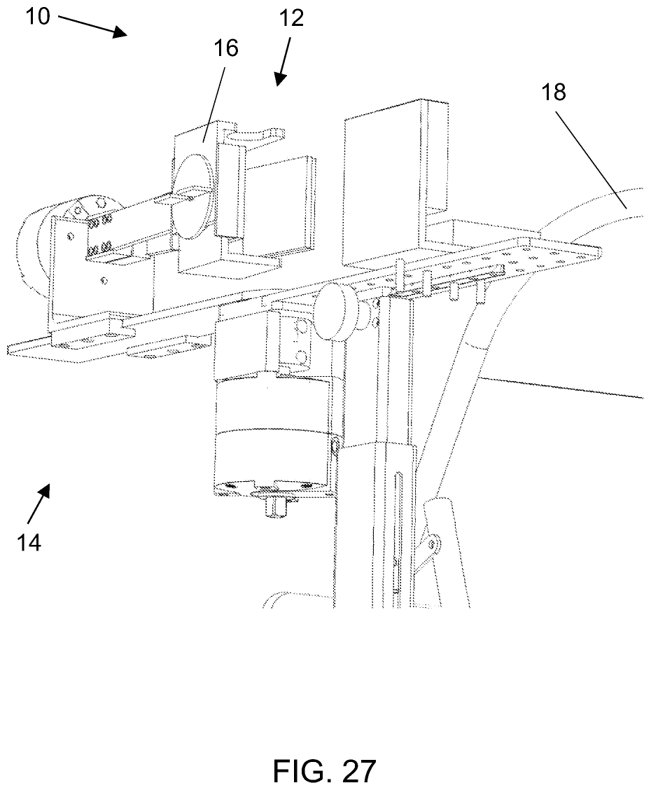

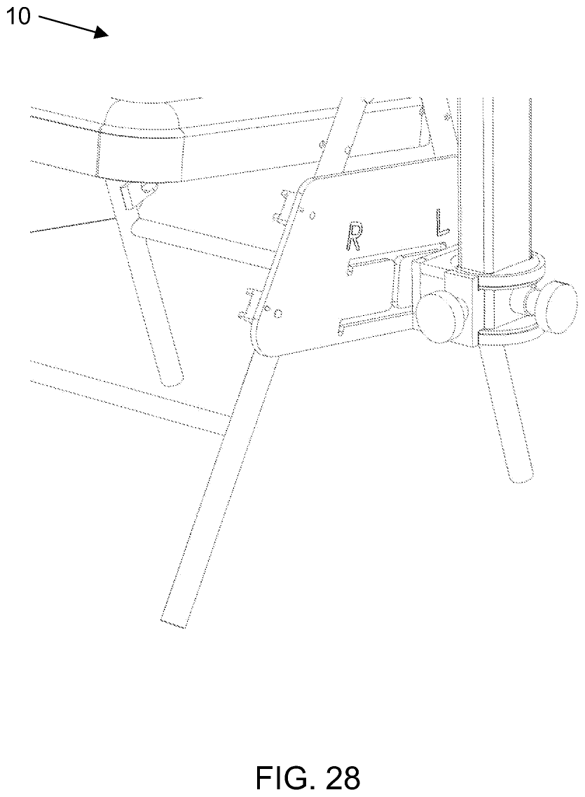

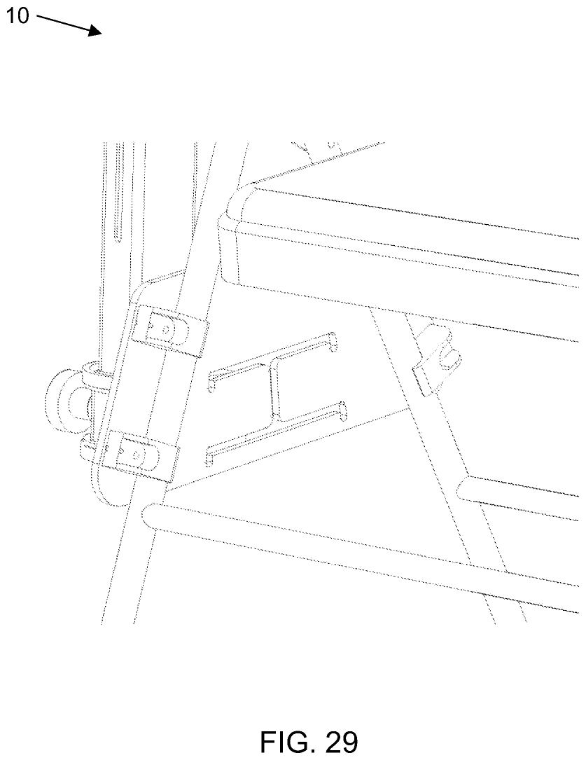

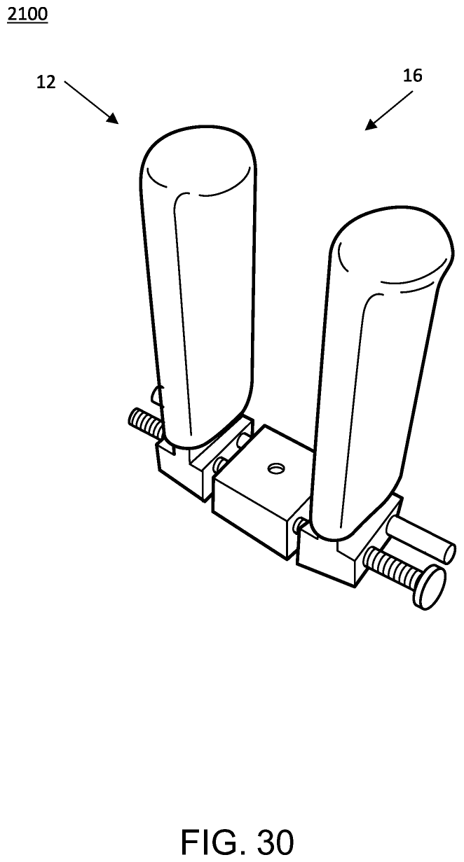

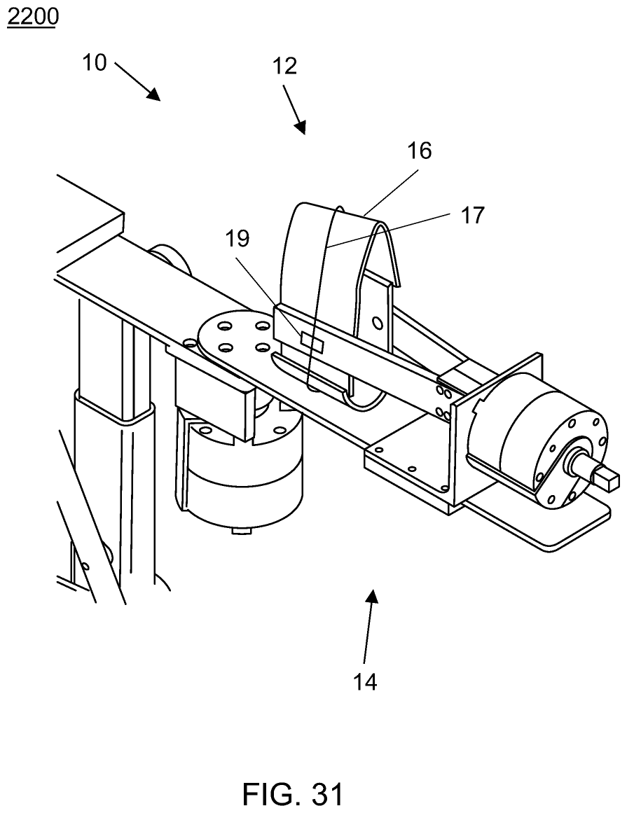

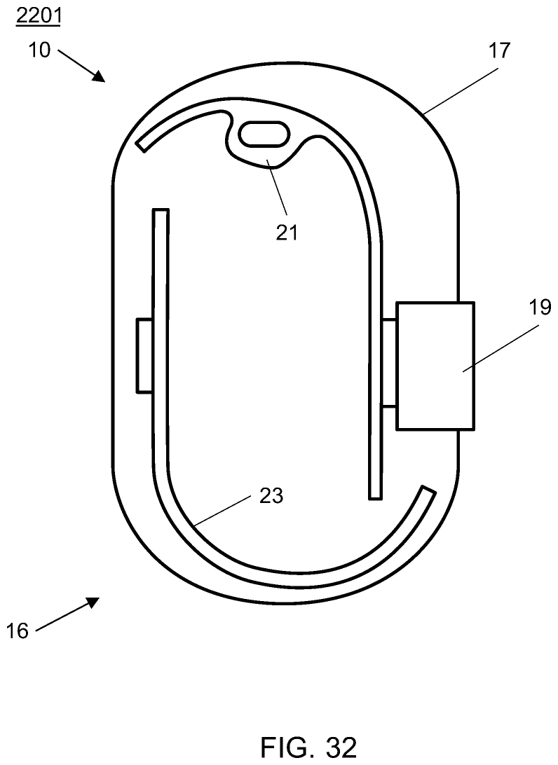

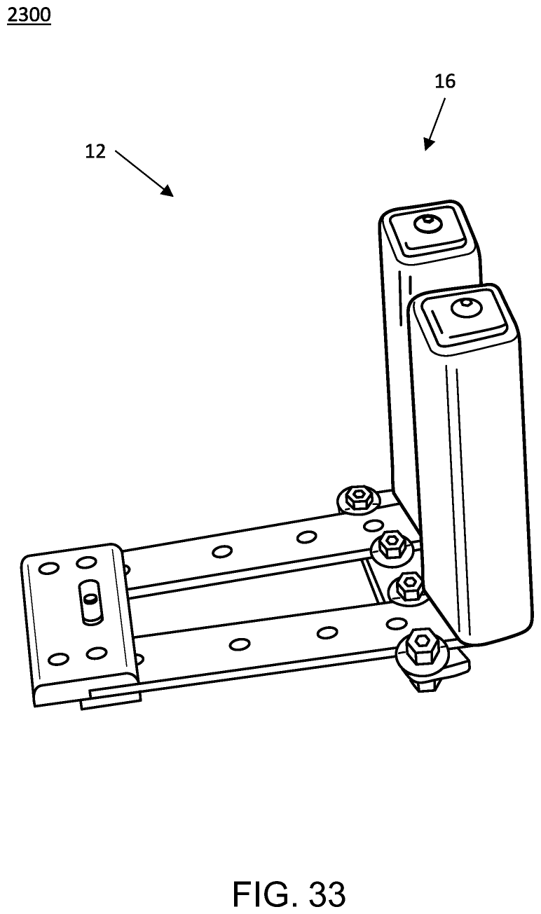

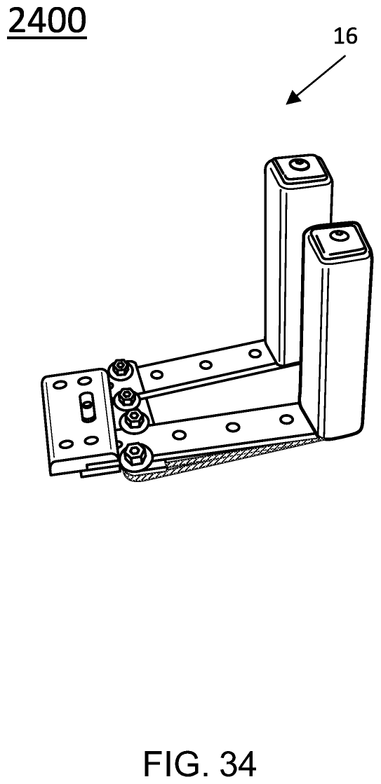

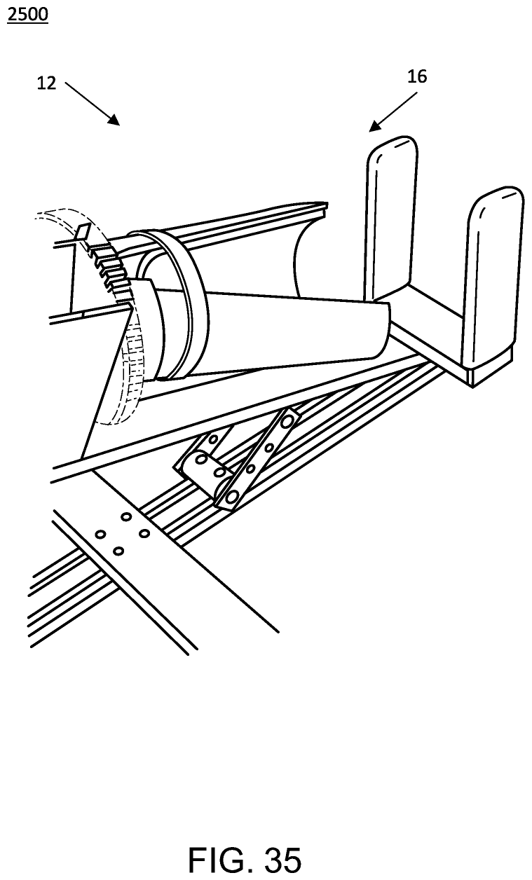

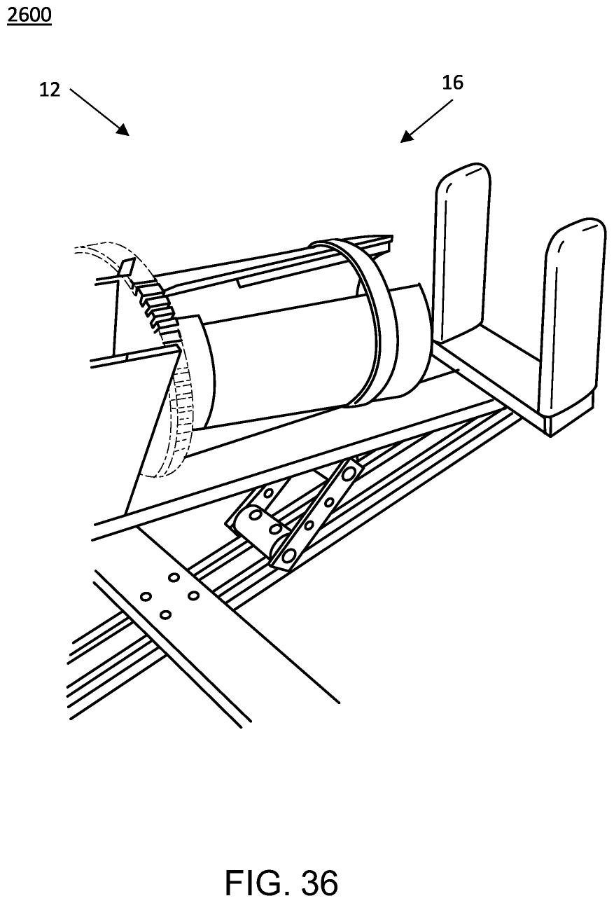

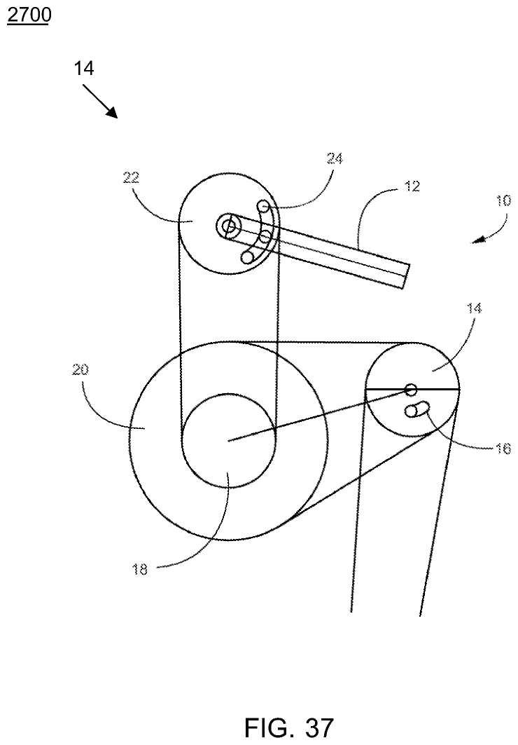

Referring now to FIGS. 1-35, exemplary embodiments of an upper extremity support and range of motion device 10 are illustrated according to example embodiments of the present invention. It should be noted that as used herein the upper extremity support and range of motion device may be simply referred to as “the device” and/or “the machine.” As shown, the device 10 generally includes an arm engagement system 12 (e.g., including an arm support member 12a and a supporting frame member 12b) and a force application system 14. As shown in FIGS. 1-9, the device 10 may include any suitable seat, bench, or other seating surface (e.g., a chair 18) coupled to the device such that the device is configured for the user to be seated while using the device. In example embodiments, the device 10 may be releasably coupled to any suitable seat or other support provided by a physician, physical therapist, clinician, or the user's themselves. Further, although the arm engagement system 12 and the force application system 14 are shown on particular sides of the chair 18, it should be understood that the position of these components are interchangeable depending upon which wrist is injured or needs pronation/supination, flexion/extension, and radial/ulnar deviation assistance. Similarly, it is possible for the arm engagement system 12 and the force application system 14 to be on the same side and for a remote or other device to extend from the force application system 14 in order for a user to adjust the device with the other, non-injured hand. Thus, disclosed herein are various embodiments of a device 10 for manipulating a wrist or hand of a user to provide pronation/supination, flexion/extension, and radial/ulnar deviation assistance.

The arm engagement system 12 generally includes an arm support member 12a for supporting a user's arm while using the device 10 and a supporting frame member 12b for supporting the arm support member and for coupling the arm engagement system to the seat 18. In example embodiments, the arm support member 12a is generally horizontal and parallel to a support surface beneath the chair 18. The supporting frame member 12b, on the other hand, is generally vertical and perpendicular to the support surface. In alternate embodiments, any suitably sized and shaped supporting frame member 12b may be used. For example, the supporting frame member 12b may be trapezoidal or any other quadrilateral shape in order to provide additional supporting structure to the hand engagement member 16 by coupling to more than one leg of the chair or other seat support 18. In particular embodiments, the supporting frame member 12b is releasably coupled to the seat 18. For example, one or more attachment mechanisms may be used to secure the arm engagement system 12 to the chair.

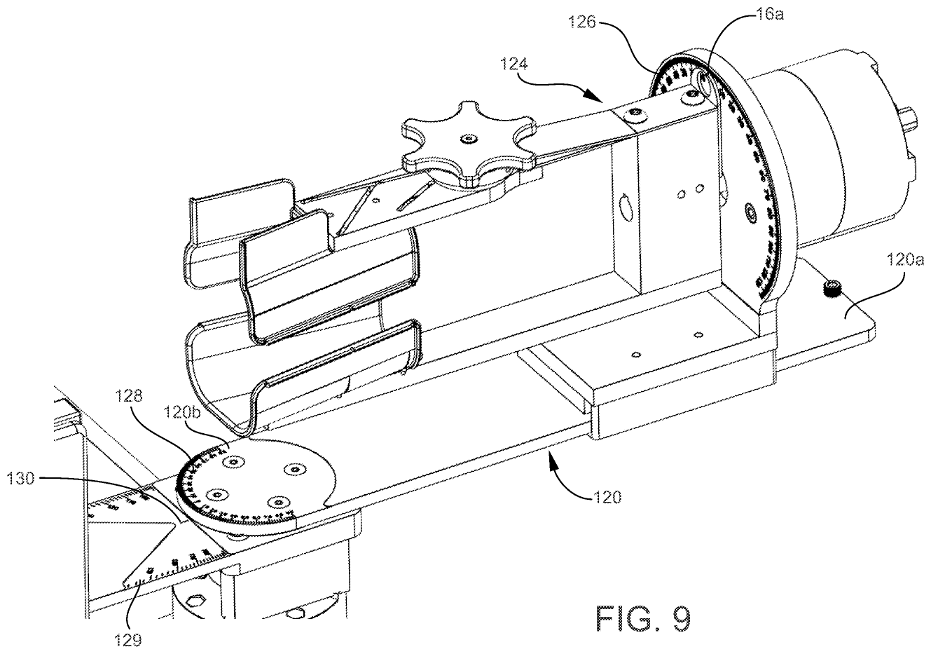

In example embodiments, the arm support member 12a may be releasably, permanently, or semi-permanently coupled to the supporting frame member 12b. In particular embodiments, the arm support member 12a is adjustable with respect to the supporting frame member 12b vertically and/or horizontally in order to accommodate users of various shapes and sizes. In example embodiments, the arm support member 12a includes a first end or wrist portion/member 120 and a second end or forearm portion/member 122, the first end being pivotally coupled to the second end. Similarly, the first end 120 of the arm support member has a proximal end or portion 120a and a distal end or portion 120b. Proximate the distal end 120b of the arm support member 12a first end 120, a bracket 124 is coupled to the arm support member for supporting and securing the arm engagement system 12 to the arm support member. In example embodiments, the bracket 124 is generally L-shaped and substantially rigid, but may be any other suitable shape or constructed of any suitable material to support the arm support member 12a. In examples where the bracket 124 is L-shaped, a hand engagement member 16 is coupled to a first surface of the vertical portion of the bracket, and an upper actuator 22 is coupled to an opposing, second surface of the vertical portion of the bracket. One or more apertures (not shown) allow the upper actuator 22 to be operatively coupled to the hand engagement member 16 for rotating the hand engagement member with respect to the first end 120 of the arm support member 12a. In example embodiments, the upper actuator 22 is a cylindrical rotary actuator. In various embodiments, the upper actuator 22 rotates clockwise and counterclockwise with respect to the anterior-posterior axis with respect to the anatomic position. In particular embodiments, the vertical portion of the bracket 124 is generally rounded and follows the curvature of the hand engagement member 16 as it is rotated by the upper actuator 22. In this particular embodiment, the vertical portion of the bracket 124 includes a first series of numbered measurements 126 (as shown in FIG. 9) indicating the degree of rotation of the hand engagement member 16.

Referring specifically to FIG. 9, the hand engagement frame 16a, as discussed further below, may include a pointer that aligns with a particular numbered measurement on the bracket 124 to easily determine the degree of rotation as the hand engagement member 16 is rotated by the upper actuator 22. In example embodiments, the proximate portion 120a of the arm support first end 120 includes a second set or series of numbered measurements 128 that also indicate the degree of rotation of the arm support first end as it is rotated by the upper actuator 22.

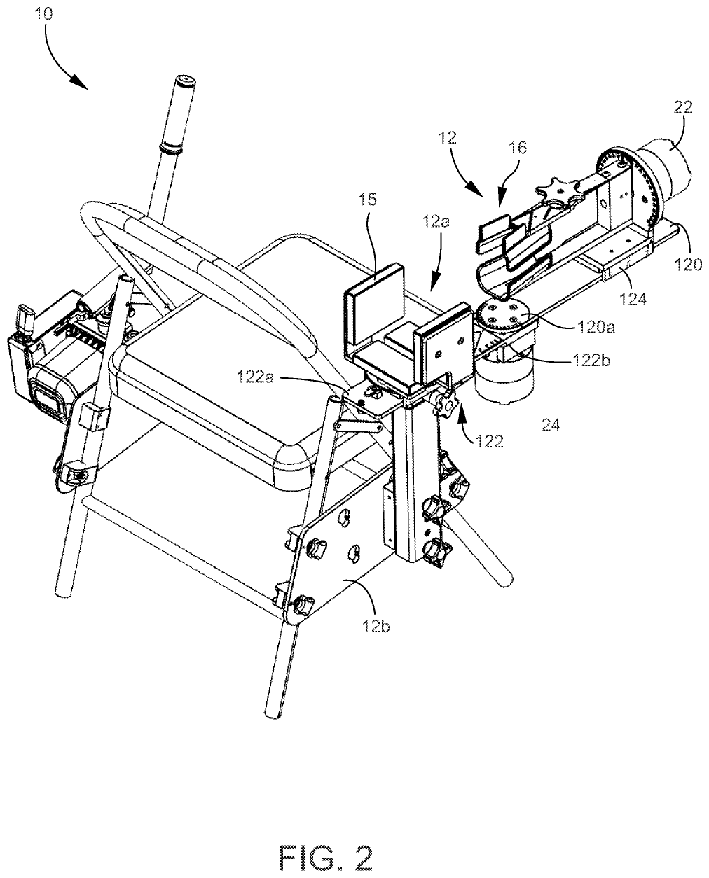

Referring to FIG. 2, the arm support member 12a second end 122 also has a proximal end/portion 122a and a distal end/portion 122b. The arm support second end distal portion 122b is coupled to the proximal end 120a of the first end 120 of the arm support member 12a. As discussed, the arm support first end 120 rotates with respect to the arm support second end 122. Proximate the proximal end 122a of the arm support second end 122, a third series or set of numbered measurements 129 (as shown in FIG. 9) are included to indicate when the first end 120 of the arm support member 12a has passed 90 degrees. A notch 130 on the arm support second 122 may be used to indicate a particular number from the second series of numbers 128 on the arm support first end 120.

Referring again to FIG. 2, the arm support second end proximal portion 122a further includes a lower actuator 24, coupled to a surface opposite the third set of numbered measurements 129. One or more apertures (not shown) allow the lower actuator 24 to be operatively coupled to the arm support member 12a first and second ends 120, 122 for rotating the first end with respect to the second end 122. In example embodiments, the lower actuator 24 is also a cylindrical rotary actuator. Both actuators 22, 24 are capable of rotating the respective coupled components clockwise or counterclockwise. In various embodiments, the lower actuator 24 rotates clockwise and counterclockwise with respect to the longitudinal axis with reference to the anatomical position. In example embodiments, the various sets of numbered measurements 126, 128, 129 may include any suitable electronic device that can be coupled to the actuators or other device components to calculate and measure the degrees of motion achieved by the user.

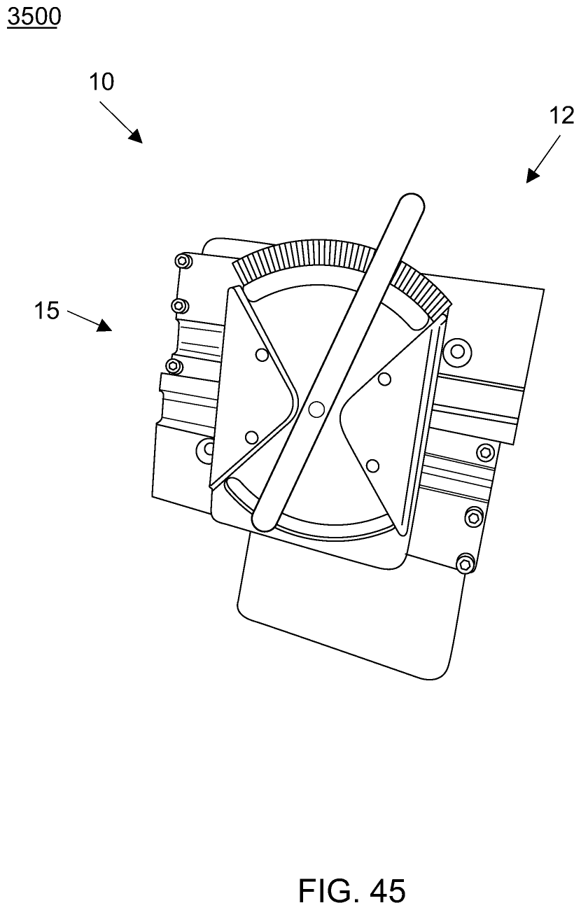

Proximate the arm support second end distal portion 122b is an elbow or forearm pad 15 configured to support a user's elbow and/or forearm. In particular embodiments, the elbow pad may 15 may be flat. In some embodiments, the elbow pad 15 is generally U-shaped to help retain the user's arm in the correct position while using the device 10 to improve the efficacy of the device 10. In some embodiments, the elbow pad 15 may include one or more adjustment mechanisms (as shown in FIG. 45) for adjusting the placement of the elbow pad 15 with respect to the arm support second end proximal portion 122a and/or for adjusting the width of the elbow pad to accommodate various users. Any suitable adjustment mechanism may be used to adjust the width of a U-shaped elbow pad 15. For example, a dovetail slide may be utilized, allowing for the vertical pads on either side of the elbow pad to be adjusted at the same rate. This allows for the arm to remain centered with respect to the hand engagement member 16. In this example embodiment, a level fits into the bottom of the centerpiece of the dovetail slide that allows for adjustment of the pad width using a nub and a series of apertures. A piece of plastic may be attached over the slider, allowing a user to more easily adjust the width of the pads.

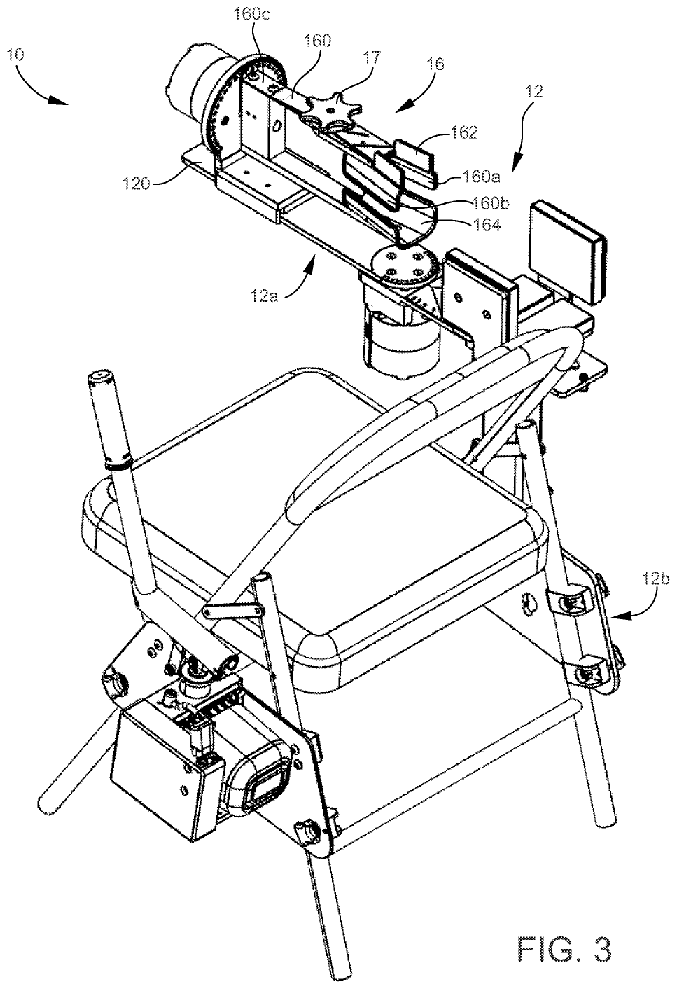

A wrist or hand engagement member 16 is coupled to the arm engagement system 12 proximate the arm support member 12a first end 120 such that a user may place their hand within the hand engagement member 16 for using the device 10. In example embodiments, the hand engagement member 16 includes a frame 160 and a hand support 162, as shown in FIG. 3. The hand engagement frame 160 may be U-shaped and constructed of any suitable, preferably rigid material that provides support while using the device 10. For example, the hand engagement frame 160 may include a first hand retention member 160a and a second retention member 160b extending away from an actuator-coupling portion 160c. In alternate embodiments, the hand engagement frame 160 may be any suitable shape or material. In particular embodiments, the hand engagement frame 160 includes one or more pads 164 or other similar material for providing a comfortable experience for a user while using the device 10.

In various embodiments, the hand engagement frame 160 includes a tension mechanism 17 (e.g., covered wire or the like) including a take-up mechanism (not shown), (e.g., a dial, knob, ratchet, or the like). The tension mechanism 17 may be secured relative to one of the posterior hand retention member 160a or the anterior retention member 160b. Likewise, the take-up mechanism may be secured to one of the posterior hand retention member 160a or the anterior retention member 160b. In some embodiments, each of the tension mechanism 17 and the take-up mechanism may be secured relative to the same retention member of the hand engagement member 16, with the length of the tension mechanism looped around at least a portion of each of the posterior hand retention member 160a and the anterior retention member 160b. For example, the tension mechanism 17 may extend from the take-up mechanism, loop around the posterior hand retention member 160a (or a portion thereof), loop around the anterior hand retention member 160b (or a portion thereof), and then be selectively or permanently fixed relative to the posterior hand retention member 160a, the posterior arm, and/or the take-up mechanism. Alternatively, the tension mechanism 17 may extend from the take-up mechanism, loop around the posterior hand retention member 160a (or a portion thereof), loop around the anterior hand retention member 160b (or a portion thereof), and then be selectively or permanently fixed relative to the anterior hand retention member 160b and/or the anterior arm.

Generally, when the take-up mechanism is activated to shorten a length of the tension mechanism 17 extending from the same, the circumference of the exposed portion of the tension mechanism 17 is reduced and a force is applied to the posterior hand retention member 160a and/or the anterior retention member 160b in order to secure the hand of the user there between. Alternatively, the take-up mechanism may be released and/or activated to extend the length of the tension mechanism 17 extending from the same, increase the exposed portion of the tension mechanism, and reduce the force applied to the hand between the posterior hand retention member 160a and/or the anterior retention member 160b.

In various embodiments described herein, the tension mechanism 17 may include a cable, belt, line, elastic band, inelastic band, chain, wire, ribbon, or some combination of the foregoing, and/or the like. In various embodiments, the take-up mechanism may refer to any mechanism that applies a force, such as, but not limited to hydraulic drive mechanisms, rotary actuators, hydraulic actuators, pneumatic actuators, electric motors, actuators and associated power and/or control mechanisms, harmonic drive mechanisms, pneumatic drive mechanisms, planetary gear mechanisms, rotary mechanisms (e.g., continuous, non-incremental, incremental and/or the like), inflatable members, manual (e.g., user-generated) force application, winches, springs, and/or the like.

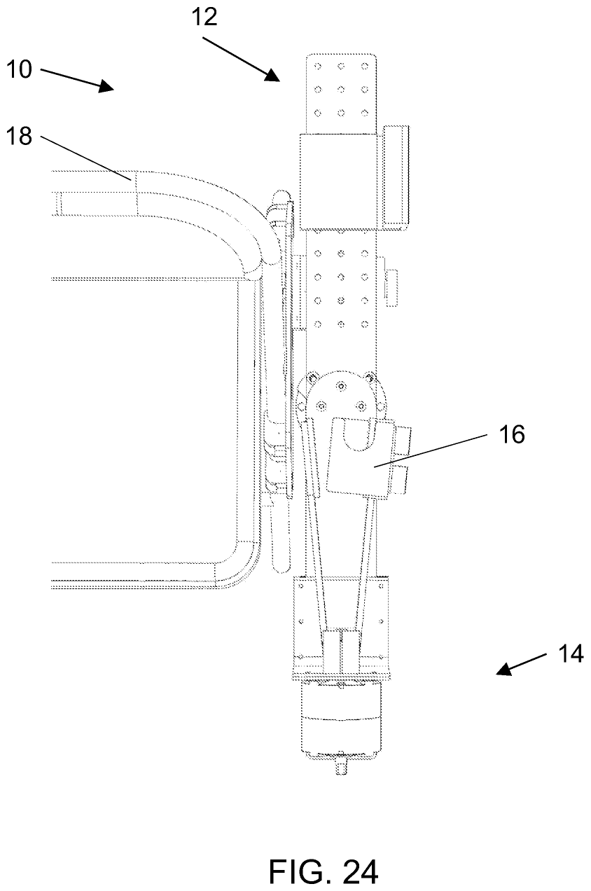

In example embodiments, the hand support 162 may be releasably, permanently, or semi-permanently coupled to the hand engagement frame 160. In example embodiments, the hand support 160 is constructed of a flexible or semi-flexible material. The hand support 160 is generally U-shaped or V-shaped to easily retain and hold a user's hand. In some embodiments, the hand support 160 includes a thumb cutout 166 (as shown in FIG. 24) allowing a user's thumb to extend outside of the hand support. This cutout 166 may be beneficial in properly aligning a user's hand in the machine 10, as well as when instructing a user on how to use the machine. For example, a user may be instructed to “shake hands” with the hand support 160 in order to properly use the device 10. In particular embodiments, the hand support 162 may include one or more fasteners or closure mechanisms 168 for releasably receiving a user's hand and/or for adjusting the size of the hand support based on the size of the user's hand, including, but not limited to, zippers, snaps, buttons, Velcro, grommets, elastic, etc.

In some embodiments, the hand support 162 may include additional hand retention members to ensure proper placement of a user's hand within the hand engagement member 16. Additionally or alternatively, various additional hand retention members may define one or more cavities to receive at least one digit of a user's hand. For instance, the additional hand retention members may define a cavity configured to receive or secure a user's thumb while the device 10 is in use.

Generally, the device 10 includes one or more force generators or power units 20 operatively coupled to the actuators 22, 24 in order to supply power to the arm engagement system 12 to rotate the respective actuator in order for a user to use the device for pronation/supination, flexion/extension, and radial/ulnar deviation assistance. Although described as having two actuators, any number of actuators may be used to produce the desired movement of the device 10.

In example embodiments, the power generator 20 is operatively coupled to the actuators 22, 24 through any suitable means for providing power to the actuators. For example, one or more electrical wires or hydraulic components may operatively couple the force generator 20 to the actuators 22, 24 in order for a user to properly use the device 10. In preferred embodiments, the power components or hydraulic lines are routed from the force generator 20, around the back of the seat 18, and coupled to the actuators 22, 24 in order to keep these components out of the user's way when using the device 10. In example embodiments, any suitable power source 20 may be used to power the device 10. In particular embodiments, a hydraulic system is used to power the device. In alternate embodiments, an electric motor is used to power the device.

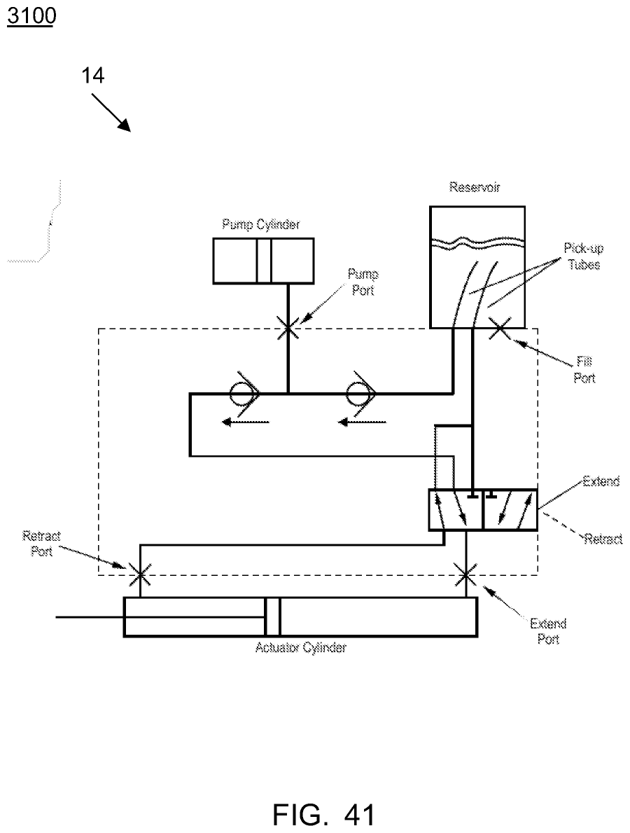

In the various figures discussed herein, hoses operatively coupling or connecting the several rotary actuators with the pump may not be shown in the figures for ease of illustration. It should be understood that the rotary actuators are typically connected by two hoses to the controller, which is connected itself by two hoses to the pump. FIG. 41 shows a schematic-type drawing of plumbing required to achieve the transfer of fluid pressure. The schematic shows one of several options available. This one includes a valve arrangement which facilitates the use of an “extend” as well as a “retract” position for the switch 416, in which the user can manipulate the switch to the “pronation” position such that pumping of the pump cylinder (“e.g. power cylinder 414) causes extension of the main cylinder (e.g. working cylinder), and whereas the user can manipulate the switch to the “supination” position such that pumping of the power cylinder causes a retraction of the working cylinder. An alternative version includes the use of springs or other suitable devices for a return feature, with pumping only being used to provide cylinder extension and the springs/etc. used to provide flexion, or vice versa.

In example embodiments, the power unit or force generator 20 includes a power unit support structure or frame, a small cylinder (a.k.a. “power cylinder”) 202, a reservoir, plumbing, a pivoting pump lever, a hand grip 204, an actuator switch 206, and a direction adjustment switch 208. The actuators 22, 24 are positioned such that reciprocating pivoting of the lever causes a pumping action to the power cylinder allowing the user to push or pull the hand grip 204 to cause the power cylinder 202 to create the necessary hydraulic energy. Such pumping causes fluid pressurized within the power cylinder 202 to transfer fluid pressure to the actuators 22, 24 located on the arm engagement system 12 causing extension/flexion, supination/pronation, and/or abduction/adduction of a user's hand/wrist depending upon the position of the actuator switch 206 and the direction adjustment switch 208.

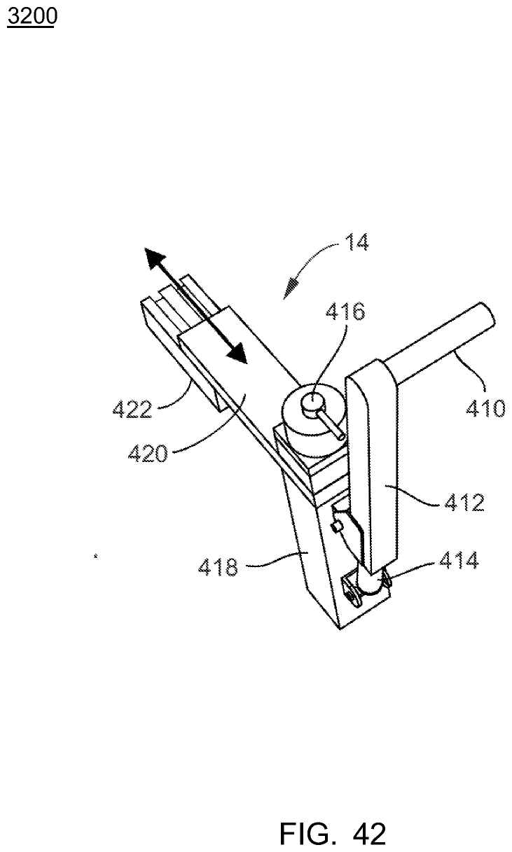

Referring to FIG. 42, a power unit support structure 418, 420, 422, a small cylinder (a.k.a. “power cylinder”) 414, a reservoir, plumbing, a pivoting pump lever 412, a hand grip 410, and an adjustment switch 416 are illustrated in accordance with aspects of the present subject matter. The working cylinder 414 is positioned such that reciprocating pivoting of the lever 412 causes a pumping action to the power cylinder 414 such that the mechanical energy of the user operating the lever 412 is converted to hydraulic energy by the power cylinder 414. Such pumping causes fluid pressurized within the power cylinder 414 to transfer fluid pressure to a second, main cylinder (a.k.a. “working cylinder”). An adjustment switch 416 is positioned on the power unit support structure 418, 420, 422. The switch 416 changes the direction of operation for the working cylinder 60 such that the user can select the desired therapeutic motion of supination or pronation. The position and operation of the working cylinder 60 is discussed elsewhere in this application. In an alternative embodiment the power unit assembly 14 is configured such that a user can engage with the power cylinder 414 using a foot lever. This enables a user to utilize a foot instead of an opposite hand for controlling the power and working cylinders 414, 60. In other alternative embodiments the power unit assembly 14 utilizes a different type of system to generate the required energy for moving the arm device. For example the power unit may be a mechanical device having a series of gears providing a mechanical advantage based on the gearing.

In example embodiments, the actuator switch 206 and the motion or direction adjustment switch 206 may be positioned on the power unit 20 or on the arm engagement system 12. The actuator switch 206 is configured to change which actuator 22, 24 receives power from the power unit. The direction adjustment switch 208 is configured to change the direction of operation for either the upper actuator 22 or the lower actuator 24, depending upon the position of the actuator switch, such that the particular actuator 22, 24 moves in either a first direction or a second direction, allowing the user to select the desired therapeutic motion for the particular actuator (ulnar/radial deviation, pronation/supination, extension/flexion), as discussed further below.

Ulnar/Adduction and Radial/Abduction Deviation of the User's Wrist Using the Device

When the actuator switch is positioned to power the lower actuator 22, the direction switch is positioned in a first position, and the user's hand is placed palm down within the hand engagement member 16 (either by adjusting the upper actuator 22 such that the hand engagement member is rotated to position the user's hand palm down, or by the user placing their hand in the hand engagement member palm down), the device 10 is configured to cause an ulnar deviation of the user's wrist. Conversely, if the direction switch is positioned in a second position, but the other factors remain the same, the device 10 is configured to cause a radial deviation of the user's wrist.

Pronation and Supination of the User's Wrist Using the Device

When the actuator switch is positioned to power the upper actuator 22, the direction switch is positioned in a first position, and the user's hand is placed as if the user were shaking hands with the upper actuator within the hand engagement member 16, the device 10 is configured to cause the user's wrist to move into a supination position. Conversely, if the direction switch is positioned in the second position, and all other factors remain the same, the device 10 is configured to cause the user's wrist to move into a pronation position.

Extension and Flexion of the User's Wrist Using the Device

When the actuator switch is positioned to power the lower actuator 24, the direction switch is positioned in a first position, and the user's hand is placed as if the user were shaking hands with the upper actuator within the hand engagement member 16, the device 10 is configured to cause extension of the user's wrist. Conversely, if the direction switch is positioned in the second position, the device 10 is configured to cause flexion of the user's wrist.

Method of Using the Device

In order to use the device 10, a user may sit in the chair 18 with their back flat against the back support. All jewelry should be removed from the hand and wrist prior to using the device. The user may then slide their hand inside the hand piece or hand engagement member 16. The user's forearm should rest on the forearm/elbow pad 15. Once in this position, the user or an assistant may tighten the tension mechanism 17 using the take-up mechanism or knob until the hand piece fits snugly around the user's hand. The device 10 is unique in that a user is able to easily switch between the various modes of operation (pronation/supination, flexion/extension, and abduction/adduction) on their own without the assistance of another person. The elbow or forearm pad 15 may also be tightened around the user's forearm to ensure the user's arm and wrist are properly centered within the device.

For pronation and supination, palm up to palm down, the wrist portion and the forearm portion should be aligned in a straight line. Using the upper actuator 22, a user may switch between the pronation position and the supination position.

For flexion and extension, the hand engagement member 16 should be positioned so the user's hand is in a thumb's up position. Using the lower actuator, a user may switch between the flexion position and the extension position.

For abduction and adduction, the hand engagement member 16 should be positioned so the user's hand is palm-side down. Using the lower actuator 24, a user may switch between the abduction position and the adduction position.

For each of the different stretches (pronation/supination, flexion/extension, and abduction/adduction) the following steps should be followed: with the user's hand in the device, the hand grip may be pumped to move either the hand engagement member or the wrist portion, depending upon the position of the actuator switch and the direction switch. The stretch should be held for 10 minutes. Changing the position of the direction switch and pumping the handle will move the device in the opposite direction, thereby reducing the stretching load on the forearm/wrist. The user may relax the forearm and wrist for 10 minutes to allow the muscles and the tissues around the wrist and forearm to recover from the stretch. The stretching and relaxing steps should be repeated at least once more.

Although described with the user's hand in a particular orientation to achieve the desired improvement in wrist motion, some user's may be unable to begin using the device with their hand/wrist in the described orientation due to the nature of their injury or other factors such as age, illnesses such as arthritis, etc. Therefore, another beneficial aspect of this device is that the stretches can be done with the user's hand/wrist in any position. For example, where a user cannot place their hand in a thumb's up position, for instance, their hand is stuck in a pronation position, the device 10 can be adjusted with the upper actuator 22 to align the hand engagement member 16 with the user's hand position (where the user feels comfortable and wherever their current limit of pronation/supination may be), and then the lower actuator 24 may be used to stretch the user's wrist between flexion/extension and/or radial/ulnar deviation.

### ALTERNATE EMBODIMENTS

In an alternative embodiment, the power unit assembly 20 is configured such that a user can engage with the power cylinder using a foot lever. This enables a user to utilize a foot instead of an opposite hand for controlling the power and actuators.

In other alternative embodiments, the power unit assembly 20 utilizes a different type of energy to create the required energy for moving the device. Examples include, but are not limited to, an electric motor, pneumatics, mechanical rotational gears, or rack and pinion.

In other alternative embodiments, the power unit assembly 20 utilizes a different type of system to generate the required energy for moving the device. For example the power unit may be a mechanical device having a series of gears providing a mechanical advantage based on the gearing.

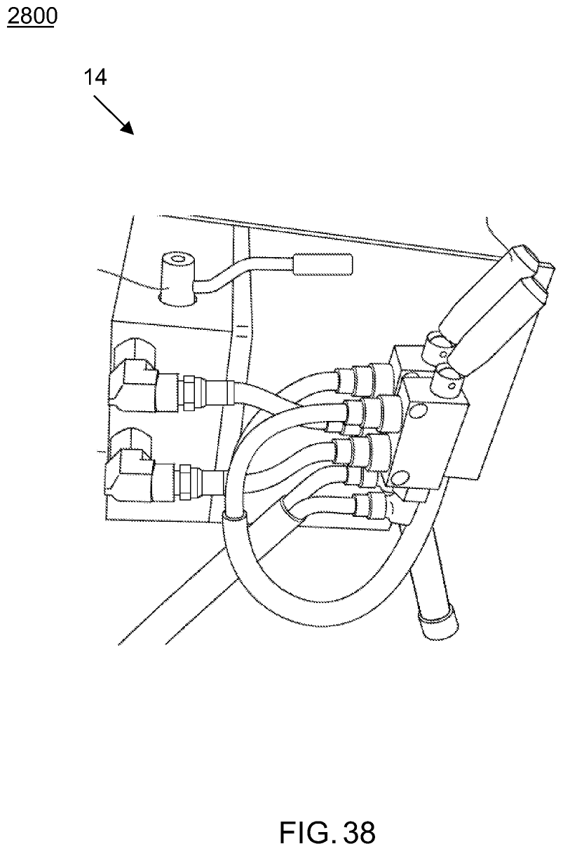

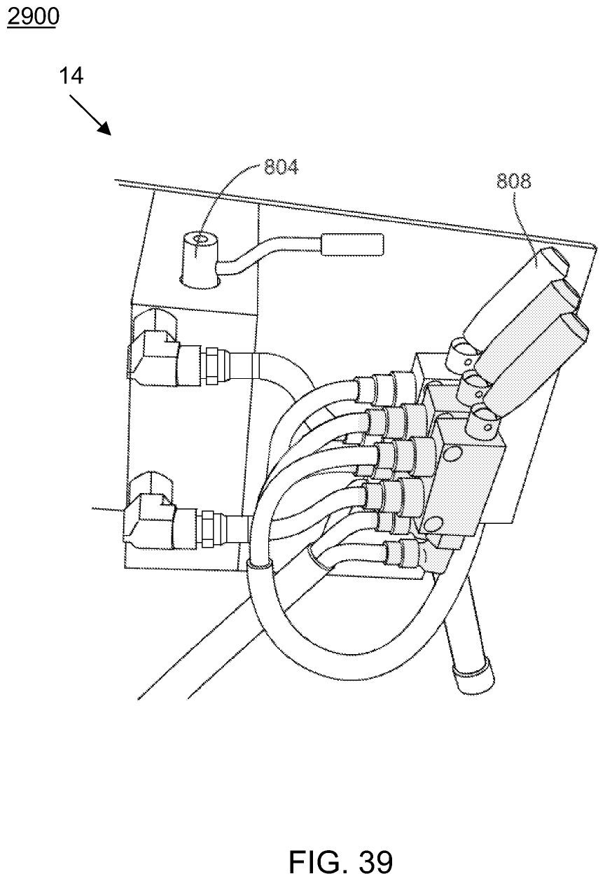

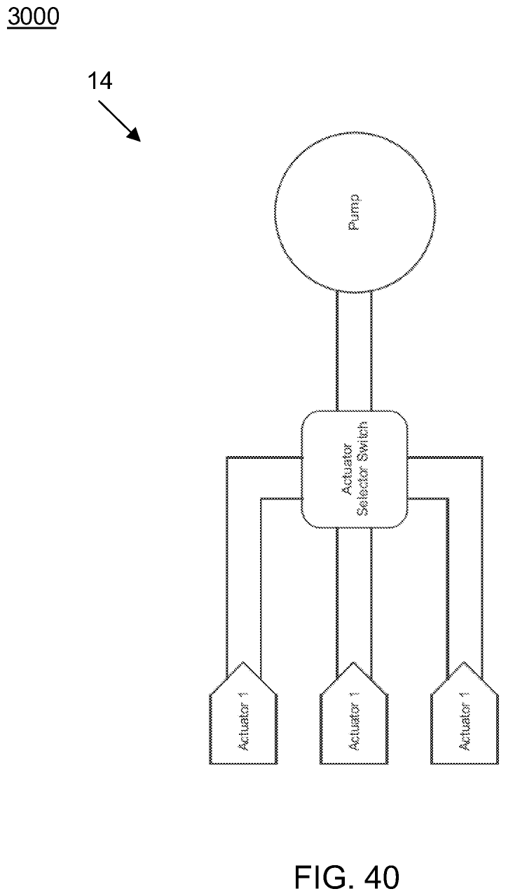

As shown in FIGS. 38-42 and for example, a control mechanism for controlling two actuators that includes a forward-reverse switch and two actuator on-off switches. Referring to FIG. 39, a control mechanism for controlling three actuators that includes a forward-reverse switch and three actuator on-off switches is depicted in accordance with aspects of the present subject matter. Similarly, if four actuators needed to be controlled, four on-off switches could be used, still with two hoses going from the on-off switches to the pump. FIG. 40 illustrates a block diagram of an exemplary control system according to embodiments of the invention. As shown, actuators may be connected to the control switches via two hoses each. The control switches determine whether each particular actuator is on or off. In such an embodiment, only one actuator may be on at a time. The control switches are connected to the pump via two hoses.

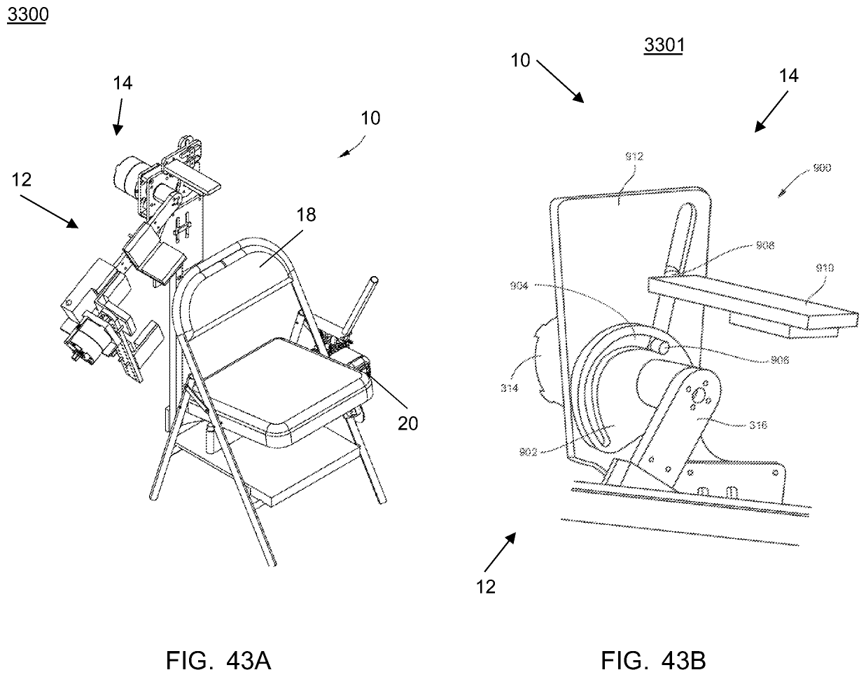

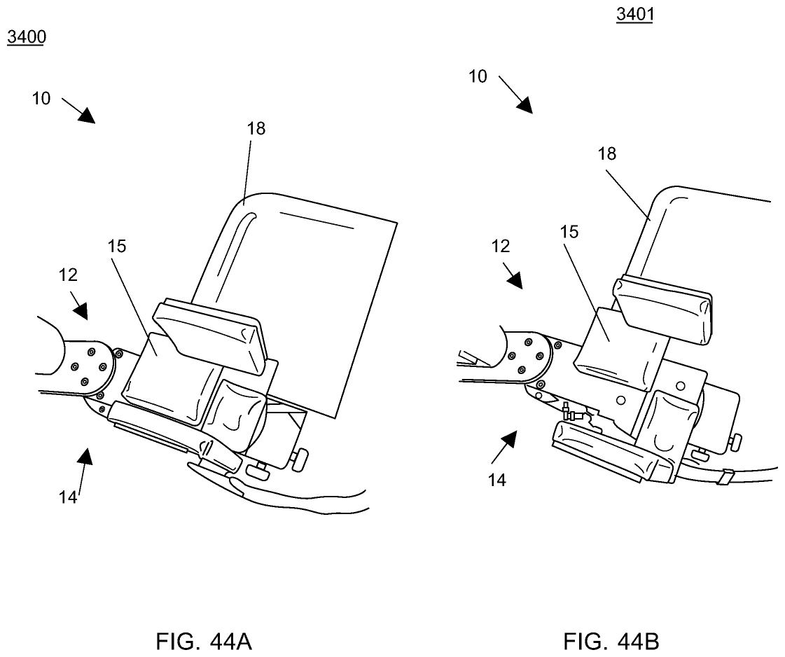

In additional or alternative embodiments, the arm engagement system 12 may be supported relative to the chair 18 at approximately shoulder level (e.g., coupled to the chair 18 and/or an independent support structure, such as a post, column, or the like). In such embodiment, e.g., as shown in FIG. 43A, the proximal end of the proximal arm member may be coupled to a distal end of an upper proximal arm of the arm engagement system 12. A proximal end of the upper proximal arm may be configured to pivot about an axis defined through the shoulder joint (e.g., generally along an anterior-posterior extending axis) such that the arm engagement system 12 and the arm of the user is configured to selectively rotate in a generally lateral and/or vertical motion about an axis configured to extend through the shoulder joint of the user, when the device 10 is in use. As such, the device 10 may include at least one pivoting connection (e.g., a third and/or fourth pivoting connection) operatively coupled between an upper proximal arm frame (e.g., at or near the proximal end thereof) of the upper proximal arm and the support structure.

In some embodiments, the force application system 14 may include one or more additional force applicators operatively connected between the proximal arm frame and the upper proximal arm frame and configured to apply a force to the hand engagement member 16 to pivot the hand engagement member 16 about the axis defined through the shoulder joint. In various embodiments, additional force applicator(s) may include one or more hydraulic actuators, pneumatic actuators, rotary actuators, an electric motor and/or an actuator and associated power and/or control mechanisms, other suitably configured actuators, and/or the like.

In some embodiments and as shown, the upper proximal arm frame may include one or more posterior upper arm pads, lateral upper arm pads, or combinations of the same configured to engage respective portions of the upper arm of the user while the device 10 is in use. Additionally or alternatively, the arm engagement system 12 may include one or more shoulder pads configured to engage the shoulder of the user while the device 10 is in use.

As shown in FIGS. 43A-3B, also disclosed is a device 901 according to an additional or alternative embodiment of the invention having a cam mechanism 900 wherein a cam 902 having a channel 904 is rotated by an actuator 314 of the device 10 and/or the force application system 14. Follower 906 moves with the cam's 902 rotation and translates the movement into follower 908 and the shoulder pad.

Particular embodiments and features have been described with reference to the drawings. It is to be understood that these descriptions are not limited to any single embodiment or any particular set of features. Similar embodiments and features may arise or modifications and additions may be made without departing from the scope of these descriptions and the spirit of the appended claims. The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims.

What is claimed is:

1. A device for improving a user's pronation, supination, flexion, extension, radial deviation, and ulnar deviation wrist movements, the device comprising:
an arm engagement system comprising:
a wrist portion comprising a proximal end and a distal end, the distal end comprising a bracket, wherein a hand engagement member is pivotally coupled to the wrist portion by the bracket;
a forearm portion comprising a proximal end and a distal end, wherein the proximal end comprises a forearm pad; and
a pivoting connection operatively coupled with the proximal end of the wrist portion and the distal end of the forearm portion, wherein the wrist portion is pivotally coupled to the forearm portion about the pivoting connection; and
a force application system comprising:
a first actuator operatively coupled to the hand engagement member; and
a second actuator operatively coupled at or near the pivoting connection,
wherein the first actuator is configured to apply a rotational force to the hand engagement member, thereby producing at least one of a supination movement and a pronation movement to a user's wrist, and
wherein the second actuator is configured to apply a rotational force to the pivoting connection, thereby producing at least one of a flexion movement, extension movement, ulnar deviation, and radial deviation of a user's wrist.

2. The device of claim 1, wherein the device further comprises a seat.

3. The device of claim 2, wherein the seat comprises a first side and a second side, wherein the arm engagement system is coupled to the first side of the seat and the force application system is coupled to the second side of the seat.

4. The device of claim 1, wherein the first actuator is operatively coupled to the arm support first end and second actuator is operatively coupled to the arm support second end.

5. The device of claim 1, wherein the force application system is a hydraulic system.

6. The device of claim 5, wherein the hydraulic system is powered by a hand pump adapted for use with an arm of a user not being manipulated.

7. A method of using a device for improving a user's pronation, supination, flexion, extension, radial deviation, and ulnar deviation wrist movements, the method comprising:
providing an arm engagement system, the arm engagement system comprising a wrist portion, a forearm portion, and a pivoting connection pivotally coupling the wrist portion and the forearm portion, wherein the wrist portion comprises a hand engagement member configured for receiving a user's hand;
providing a force application system, the force application system comprising:
a first actuator having a first axis of rotation, wherein the first actuator is operatively coupled to the wrist portion, and wherein the first actuator is configured to rotate the hand engagement member between a first position and a second position;
a second actuator having a second axis of rotation, wherein the second actuator is operatively coupled at the pivoting connection with the wrist portion and the forearm portion; and
a power unit assembly configured to, in a first mode, actuate the first actuator, and in a second mode, actuate the second actuator,
wherein, when the wrist portion and the forearm portion are aligned in a straight line, the hand engagement member is in the first position, and the power unit assembly is in the first mode, the first actuator causes the arm engagement system to move a user's wrist between supination and pronation;
wherein, when the wrist portion and the forearm portion are aligned in a straight line, the hand engagement member is in the first position, and the power unit assembly is in the second mode, the second actuator causes the arm engagement system to move a user's wrist between ulnar deviation and radial deviation; and
wherein, when the wrist portion and the forearm portion are aligned in a straight line, the hand engagement member is in the second position, and the power unit assembly is in the second mode, the second actuator cause the arm engagement system to move a user's wrist between flexion and extension.

8. The method of claim 7, wherein when the hand engagement member is in the first position, a user's hand in the hand engagement member is positioned palm-side down.

9. The method of claim 7, wherein when the hand engagement member is in the second position, a user's hand in the hand engagement member is in a thumb's up position.

10. A device for improving a user's pronation, supination, flexion, extension, radial deviation, and ulnar deviation wrist movements, the device comprising:
an arm engagement system, the arm engagement system comprising a wrist portion, a forearm portion, and a pivoting connection pivotally coupling the wrist portion and the forearm portion, wherein the wrist portion comprises a hand engagement member configured for receiving a user's hand;
a force application system, the force application system comprising:
a first actuator having a first axis of rotation, wherein the first actuator is operatively coupled to the wrist portion, and wherein the first actuator is configured to rotate the hand engagement member between a first position and a second position;
a second actuator having a second axis of rotation, wherein the second actuator is operatively coupled at the pivoting connection with the wrist portion and the forearm portion; and
a power unit assembly configured to, in a first mode, actuate the first actuator, and in a second mode, actuate the second actuator,
wherein, when the wrist portion and the forearm portion are aligned in a straight line, the hand engagement member is in the first position, and the power unit assembly is in the first mode, the first actuator causes the arm engagement system to move a user's wrist between supination and pronation.

11. The device of claim 10, wherein, when the wrist portion and the forearm portion are aligned in a straight line, the hand engagement member is in the first position, and the power unit assembly is in the second mode, the second actuator causes the arm engagement system to move a user's wrist between ulnar deviation and radial deviation.

12. The device of claim 10, wherein, when the wrist portion and the forearm portion are aligned in a straight line, the hand engagement member is in the second position, and the power unit assembly is in the second mode, the second actuator causes the arm engagement system to move a user's wrist between flexion and extension.

13. The device of claim 10, wherein when the hand engagement member is in the first position, a user's hand in the hand engagement member is positioned palm-side down.

14. The device of claim 10, wherein when the hand engagement member is in the second position, a user's hand in the hand engagement member is in a thumb's up position.

15. A device for manipulating a hand of a user to provide pronation or supination assistance, the device comprising:
an arm engagement system including:
a proximal arm member comprising a proximal arm frame having a proximal end, a distal pivot end, and a posterior elbow pad proximate the proximal end, wherein the posterior elbow pad is configured to engage a bottom of the user's elbow;
a distal arm member comprising a distal arm frame having a proximal pivot end and a distal end;
a hand engagement member configured to receive and engage the hand of the user;
a first pivoting connection operatively coupled between distal arm frame and the hand engagement member such that the hand engagement member is configured to pivot about an axis defined along a forearm of the user as the hand of the user pronates or supinates; and
a force application system comprising:
a force applicator operatively connected between the distal arm frame and the hand engagement member, the force applicator configured to apply a force to the hand engagement member to manipulate the hand of the user to provide the pronation or supination assistance.

16. The device of claim 15, further comprising:
second pivoting connection operatively coupled between the distal pivot end of the proximal arm frame and the proximal pivot end of the distal arm frame such that the hand engagement member is configured to pivot about a vertical axis.

17. A device for manipulating a hand of a user to provide pronation or supination assistance, the device comprising:
an arm engagement system including:
a proximal arm member comprising a proximal arm frame extending along a proximal frame longitudinal direction from proximal end to a distal pivot end and including a posterior elbow pad configured to engage a bottom of the user's elbow;
a distal arm member comprising a distal arm frame extending along a distal frame longitudinal direction from a proximal pivot end to a distal pivot end;
a hand engagement member configured to receive and engage the hand of the user;
a first pivoting connection operatively coupled between the distal pivot end of the proximal arm frame and the proximal pivot end of the distal arm frame such that the hand engagement member is configured to pivot about an axis of rotation perpendicular to at least one of the proximal frame longitudinal direction or the distal frame longitudinal direction; and
a force application system comprising:
a force applicator operatively connected between the proximal arm frame and the distal arm frame, the force applicator configured to apply a force to the hand engagement member to manipulate the hand of the user to rotate about the axis of rotation.

18. The device of claim 17, wherein the hand engagement member is configured such that applying the force to the hand engagement member manipulates the hand of the user to provide for flexion or extension assistance of the wrist.

19. The device of claim 17, wherein the hand engagement member is configured such that applying the force to the hand engagement member manipulates the hand of the user to provide for radial deviation or ulnar deviation assistance.

20. The device of claim 17, wherein the arm engagement system further includes a second pivoting connection operatively coupled between distal arm frame and the hand engagement member.

21. The device of claim 20, wherein the hand engagement member is configured to pivot about the second pivoting connection between a first position suitable for flexion or extension assistance of the wrist and a second position suitable for radial deviation or ulnar deviation assistance.

22. The device of claim 20, wherein the hand engagement member is configured to pivot about the second pivoting connection and about an axis defined along a forearm of the user as the hand of the user pronates or supinates.

23. The device of claim 20, wherein the force application system further comprises:
a second force applicator operatively connected between the distal arm frame and the hand engagement member.

24. The device of claim 23, wherein the second force applicator configured to apply a force to the hand engagement member to manipulate the hand of the user to provide pronation or supination assistance.

25. A method for manipulating body parts of a user, thereby providing pronation or supination assistance to the arm of the user about a wrist joint of the user, the method comprising:
engaging a forearm of the user with a proximal arm member of an arm engagement system;
engaging a hand of the user with a hand engagement member, wherein the hand engagement member is operatively coupled to the distal arm member at a pivoting connection configured to allow the hand engagement member to pivot about an axis defined along a forearm of the user as the hand of the user pronates or supinates; and
activating a force application mechanism to apply a force to the hand engagement member to manipulate the hand of the user to provide the pronation or supination assistance, wherein a force applicator of the force application mechanism is operatively connected between the distal arm frame and the hand engagement member.

26. The method of claim 25, wherein the distal arm member is operatively coupled to the proximal arm member at a second pivoting connection configured to allow the hand engagement member to pivot about an axis defined perpendicular to the forearm of the user as the hand of the user flexes or extends about the wrist, the method further comprising:
activating the force application mechanism to apply a force to the hand engagement member to manipulate the hand of the user to provide flexion or extension assistance, wherein a second force applicator of the force application mechanism is operatively connected between the proximal arm frame and the distal arm frame.

27. The method of claim 25, wherein the distal arm member is operatively coupled to the proximal arm member at a second pivoting connection configured to allow the hand engagement member to pivot about an axis defined perpendicular to the forearm of the user as the hand of the user radially deviates or ulnarly deviates, the method further comprising:
activating the force application mechanism to apply a force to the hand engagement member to manipulate the hand of the user to provide radial deviation or ulnar deviation assistance, wherein a second force applicator of the force application mechanism is operatively connected between the proximal arm frame and the distal arm frame.
